(19) United States
(12) Patent Application Publication
(10) Pub. No.: US 2025/0093560 A1
(43) Pub. Date: Mar. 20, 2025

(54) METHODS FOR FABRICATING SURFACE-RELIEF GRATING BASED ARCHITECTURES USING FUSION BONDING

(71) Applicant: Meta Platforms Technologies, LLC, Menlo Park, CA (US)

(72) Inventors: Richard FARRELL, Seattle, WA (US); Hee Yoon LEE, Palo Alto, CA (US); Vivek GUPTA, Sammamish, WA (US)

(21) Appl. No.: 18/825,830

(22) Filed: Sep. 5, 2024

Related U.S. Application Data
(60) Provisional application No. 63/583,824, filed on Sep. 19, 2023.

(51) Int. Cl. G02B 5/18; F21V 8/00; G02B 6/12; G02B 6/122; G02B 6/124; G02B 6/132; G02B 27/00; G02B 27/01; G02B 27/42

(52) U.S. Cl. CPC G02B 5/1857; G02B 6/0016; G02B 6/1223; G02B 6/124; G02B 6/132; G02B 27/0081; G02B 27/0172; G02B 27/4272; G02B 2006/12107; G02B 2006/12176; G02B 2027/0178

(57) ABSTRACT

A method of fabricating a layered waveguide display comprises imprinting a surface-relief grating (SRG) on a first substrate, filling grating grooves of the SRG with a backfill material, depositing a first layer of an index-matching material on the SRG, and bonding the first layer of the index-matching material on the SRG to a first side of a second substrate. The first substrate and the SRG are characterized by a first refractive index and a second refractive index, respectively. The backfill material is characterized by a third refractive index greater than the first refractive index and the second refractive index. The index-matching material is characterized by a fourth refractive index greater than the first refractive index and the second refractive index. In some embodiments, the backfill material is the same as the index-matching material. The second substrate is characterized by a fifth refractive index matching the fourth refractive index.

### CROSS-REFERENCE TO RELATED APPLICATION

This application claims the benefit of and priority to U.S. Provisional Application No. 63/583,824, filed Sep. 19, 2023, entitled “METHODS FOR FABRICATING NEW SRG BASED ARCHITECTURES USING FUSION BONDING,” which is hereby incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings. Light from the surrounding environment may pass through a see-through region of the waveguide and reach the user's eyes as well.

### SUMMARY

This disclosure relates generally to waveguide-based for near-eye displays. More specifically, this disclosure relates to techniques for manufacturing layered waveguide displays including surface-relief grating couplers. Various inventive embodiments are described herein, including devices, systems, methods, processes, materials, compositions, and the like.

According to certain embodiments, a waveguide display includes a first substrate characterized by a first refractive index, a first surface-relief grating formed on a second substrate, and a first index-matching material layer between the first substrate and the first surface-relief grating. The first surface-relief grating and the second substrate are characterized by a second refractive index and a third refractive index, respectively. The first index-matching material layer fills grating grooves of the first surface-relief grating and is characterized by a fourth refractive index. The fourth refractive index matches the first refractive index. The third refractive index is lower than the first refractive index. The second refractive index is lower than the first refractive index.

In some embodiments of the waveguide display, the first refractive index is greater than about 2.0. The first surface-relief grating may be formed on the second substrate using, for example, nanoimprint lithography. The first surface-relief grating may be characterized by: a variable grating period, a variable grating depth, a variable duty cycle, a variable grating ridge slant angle, or a combination thereof. In some embodiments, the second refractive index may be between about 1.4 and about 1.9. The third refractive index may be between about 1.5 and about 2.0. In some embodiments, the first surface-relief grating may be characterized by a grating ridge slant angle between about 0° and about 70°. The first surface-relief grating may be characterized by a grating depth between about 0 and about 1 μm. The first surface-relief grating may be characterized by a duty cycle between about 0.1 and about 0.9. The first surface-relief grating may be characterized by a grating period between about 150 nm and about 700 nm. In some embodiments, the first substrate may include SiC or LiNbO₃, and the first index-matching material layer may include TiOₓ.

In some embodiments, the waveguide display may also include a second surface-relief grating formed on a third substrate, and a second index-matching material layer between the first substrate and the second surface-relief grating. The second surface-relief grating and the third substrate are characterized by a fifth refractive index and a sixth refractive index, respectively. The fifth refractive index and the sixth refractive index are lower than the first refractive index. The second index-matching material layer may fill grating grooves of the second surface-relief grating and may be characterized by the fourth refractive index.

According to certain embodiments, a method of fabricating a layered waveguide display comprises imprinting a surface-relief grating on a first substrate, filling grating grooves of the surface-relief grating with a backfill material, depositing a first layer of an index-matching material on the surface-relief grating, and bonding the layer of the index-matching material on the surface-relief grating to a first side of a second substrate. The first substrate and the surface-relief grating are characterized by a first refractive index and a second refractive index, respectively. The backfill material is characterized by a third refractive index greater than the first refractive index and the second refractive index. The index-matching material is characterized by a fourth refractive index greater than the first refractive index and the second refractive index. The second substrate is characterized by a fifth refractive index matching the fourth refractive index.

In some embodiments of the method, the backfill material may be the same as the index-matching material. Filling the grating grooves of the first surface-relief grating with the backfill material may include depositing a plurality of thin layers of the backfill material in a plurality of cycles of atomic layer deposition. Depositing the first layer of the index-matching material on the first surface-relief grating may include depositing the first layer of the index-matching material on the first surface-relief grating using physical vapor deposition. Bonding the first layer of the index-matching material on the first surface-relief grating to the first side of the second substrate may include bonding the first layer of the index-matching material on the first surface-relief grating to the first side of the second substrate by fusion bonding at a temperature below about 400° C.

In some embodiments, the method may also include etching the backfill material before depositing the layer of the index-matching material on the first surface-relief grating. In some embodiments, the method may also include depositing a second layer of the index-matching material on the first side of the second substrate, where bonding the first layer of the index-matching material on the first surface-relief grating to the first side of the second substrate may include bonding the first layer of the index-matching material on the first surface-relief grating to the second layer of the index-matching material on the first side of the second substrate.

In some embodiments, the method may also include imprinting a second surface-relief grating on a third substrate, filling grating grooves of the second surface-relief grating with the backfill material, depositing a second layer of the index-matching material on the second surface-relief grating, and bonding the second layer of the index-matching material on the second surface-relief grating to a second side of the second substrate. The third substrate and the second surface-relief grating may be characterized by a sixth refractive index and a seventh refractive index, respectively, and the sixth refractive index and the seventh refractive index may be lower than the fourth refractive index of the index-matching material.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6 illustrates examples of propagations of display light and external light in an example of a waveguide display.

FIG. 7 illustrates an example of a slanted grating coupler in a waveguide display according to certain embodiments.

FIG. 8A illustrates an example of a waveguide-based near-eye display where display light for all fields of view is substantially uniformly output from different regions of a waveguide display.

FIG. 8B illustrates an example of a waveguide-based near-eye display where display light may be coupled out of a waveguide display at different angles in different regions of the waveguide display according to certain embodiments.

FIG. 9A illustrates an example of a slanted surface-relief grating with variable etch depths according to certain embodiments.

FIG. 9B illustrates an example of a slanted surface-relief grating with variable etch depths and variable duty cycles according to certain embodiments.

FIG. 10A illustrates an example of a slanted surface-relief grating in a waveguide display according to certain embodiments.

FIG. 10B illustrates the slanted surface-relief grating of FIG. 10A with an overcoat layer formed thereon.

FIG. 11A illustrates an example of an optical see-through augmented reality system including a waveguide display and surface-relief gratings for exit pupil expansion according to certain embodiments.

FIG. 11B illustrates an example of an eye box including two-dimensional replicated exit pupils.

FIG. 12A illustrates an example of a waveguide display including a waveguide and a grating coupler formed on the waveguide.

FIG. 12B illustrates wave vectors (k-vectors) of light that may be guided by the waveguide of FIG. 12A.

FIG. 13A illustrates an example of a waveguide display.

FIG. 13B illustrates an example of a multi-layer waveguide display according to certain embodiments.

FIG. 14 illustrates an example of a multi-layer waveguide display according to certain embodiments.

FIG. 15 includes a flowchart illustrating an example of a process of fabricating a waveguide display including a layered waveguide.

FIGS. 16A-16F illustrate an example of a process of fabricating a waveguide display including a layered waveguide.

FIG. 17 includes a flowchart illustrating an example of a process of fabricating a waveguide display including a layered waveguide according to certain embodiments.

FIGS. 18A-18F illustrate an example of a process of fabricating a waveguide display including a layered waveguide according to certain embodiments.

FIG. 19 illustrates an example of a process of fabricating a waveguide display including a layered waveguide according to certain embodiments.

FIG. 20 is a simplified block diagram of an example electronic system of an example near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to waveguide-based for near-eye displays. More specifically, this disclosure relates to techniques for manufacturing layered waveguide displays including surface-relief grating couplers. Various inventive embodiments are described herein, including devices, systems, methods, processes, materials, compositions, and the like.

In near-eye display systems, it is generally desirable to expand the eyebox, improve image quality (e.g., resolution and contrast), reduce physical size, improve power efficiency, and increase the field of view (FOV). In a waveguide-based near-eye display system, display light of projected images may be coupled into a waveguide, propagate within the waveguide, and be coupled out of the waveguide at different locations to replicate exit pupils and expand the eyebox. In some implementations of the waveguide-based near eye display system, display light of the projected images may be coupled into or out of a waveguide (e.g., a substrate) using, for example, refractive optical elements (e.g., prisms), diffractive optical elements (e.g., gratings), or partial reflectors (e.g., transflective mirrors). The display light coupled into the waveguide may propagate within the waveguide through total internal reflection at surfaces of the waveguide, and may, for example, be partially diffracted by gratings when the display light propagating within the waveguide reaches the gratings. The undiffracted portion of the display light may continue to propagate within the waveguide through total internal reflection and may be partially diffracted when the display light reaches another grating. In a waveguide-based near-eye display system for augmented reality applications, light from the surrounding environment may also pass through at least a see-through region of the waveguide display (e.g., a transparent substrate) and reach the eyebox and the user's eyes. Diffractive grating couplers, such as surface-relief gratings (SRGs), polarization volume holograms (PVHs), volume Bragg gratings (VBGs), or polymer dispersed liquid crystal (PDLC) gratings, may have inherent advantages compared to traditional refractive solutions, such as using small projectors, pupil replication capability to achieve a large eyebox, low thickness (e.g., ≤0.5 mm), see-through transparency, and the like. Two or more one-dimensional or two-dimensional gratings may be used to expand the eyebox in two dimensions.

In some implementations, surface-relief gratings may be used in waveguide-based near-eye display systems to couple display light into or out of a waveguide. In general, it is desired that the waveguide has a high refractive index (RI) such that that the angular range of the display light that may be guided by the waveguide may be large and thus the waveguide display may be able to achieve a wide field of view. However, it can be difficult to fabricate SRGs in high-refractive index (high-index) substrates (e.g., SiC or lithium niobate (LiNbO₃ or LN), where the refractive index is >2.0) using techniques other than plasma (e.g., ion beam) etch techniques. For example, it is difficult to fabricate index matched gratings on high-index substrates (e.g., with RI>2.0, such as LN) using nanoimprint lithography (NIL) techniques. Using dry etch (e.g., plasma etch) based techniques to etch SRGs in high-index substrates may use many processing steps, and may be expensive and time consuming (low productivity) due to certain properties (e.g., hardness) of the high-index materials and may also have more process variations.

According to certain embodiments, a waveguide display may have a layered waveguide structure that includes a high-index substrate and one or more surface-relief gratings formed on one or more low-index substrates using techniques such as NIL, where the one or more surface-relief gratings formed on one or more low-index substrates may be bonded to the high-index substrate by, for example, fusion bonding. The SRGs may be fabricated using NIL techniques that can achieve high productivity and high yield and thus can be less expensive. The SRGs may be filled and/or deposited with a layer of a material that has a refractive index matching the refractive index of the high-index substrate such that there may be a low optical loss due to refractive index mismatch between the deposited layer and the high-index substrate. In some embodiments, a layer of the same index-matching material may be deposited on the high-index substrate before the bonding such that the bonding may be direct bonding between layers of the same material and thus may be performed at close to room temperatures. The SRGs can be imprinted to have a very thin layer (e.g., with a thickness close to zero) between the SRGs and the low-index substrate, such that the overburden (between the SRG and the low-index substrate) after bonding to the high-index substrate can be low to reduce loss due to refractive index mismatch.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

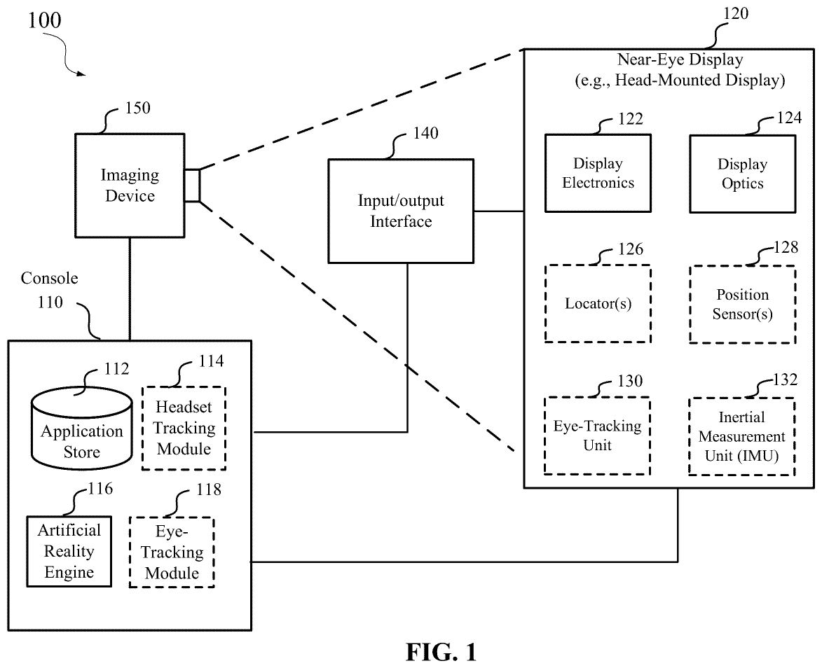

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

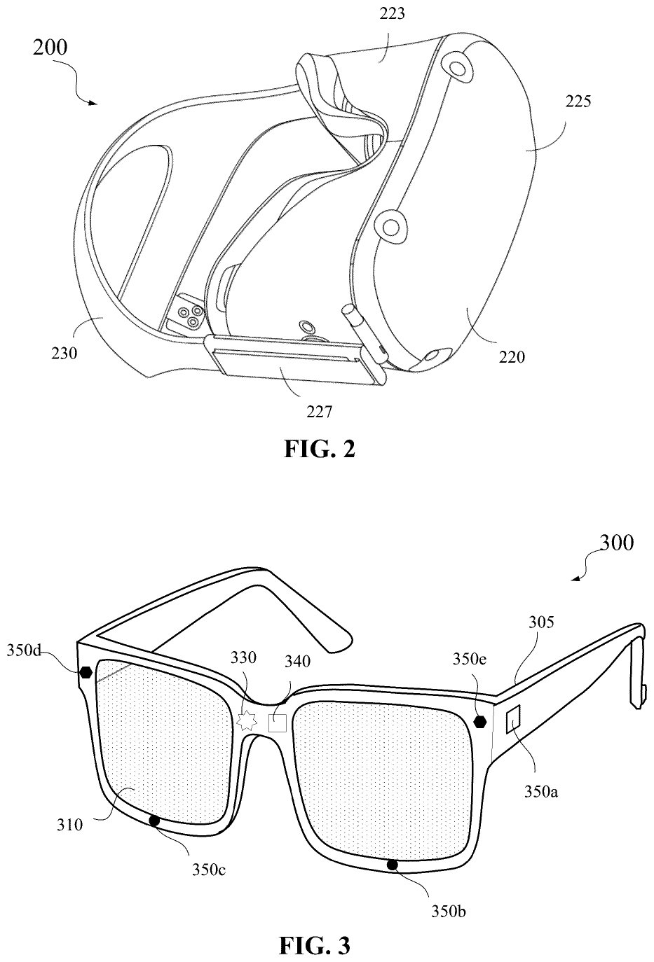

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350c on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

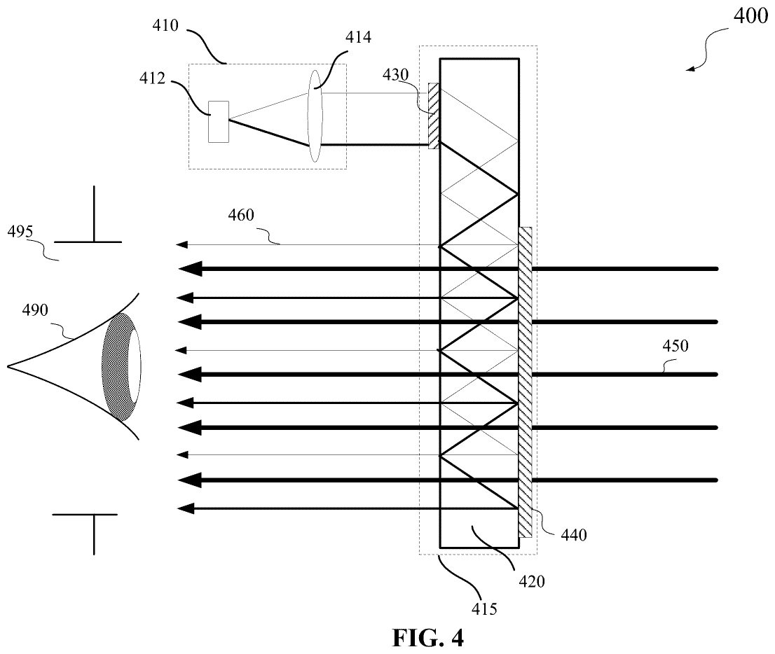

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

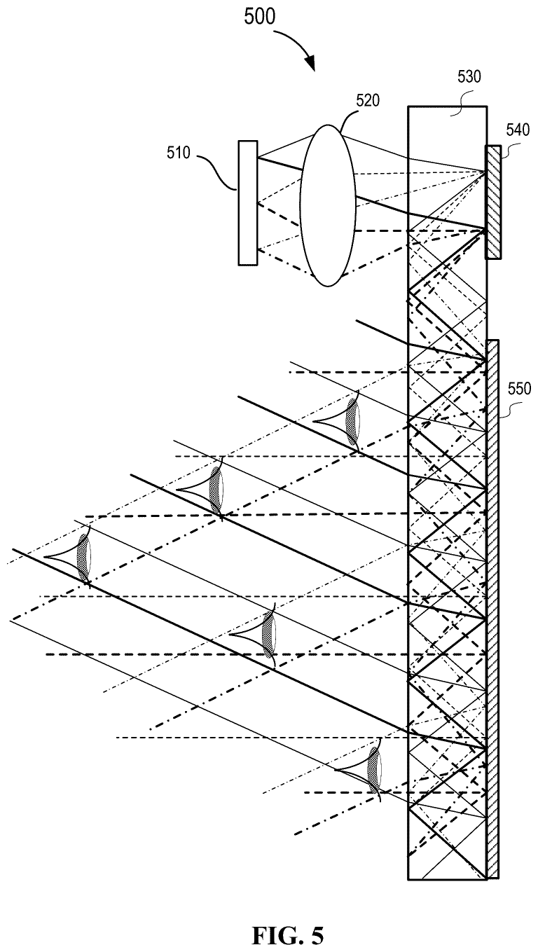

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. FIG. 5 shows that the image of the image source is visible by the user's eye even if the user's eye moves to different locations in the eyebox.

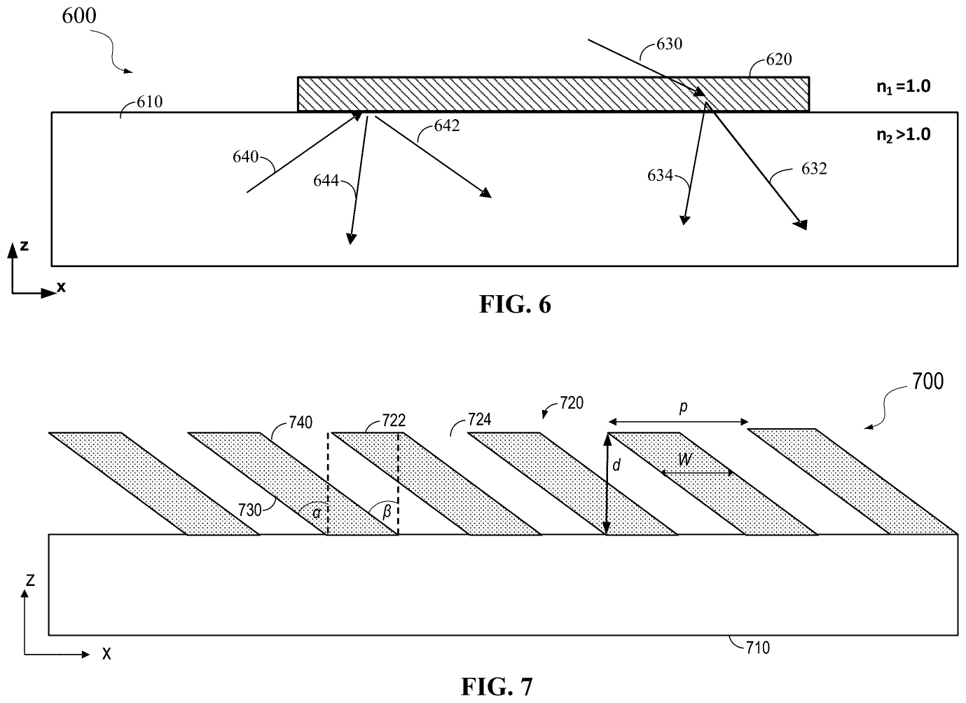

FIG. 6 illustrates propagations of display light 640 and external light 630 in an example waveguide display 600 including a waveguide 610 and a grating coupler 620. Waveguide 610 may be a flat or curved transparent substrate with a refractive index n₂ greater than the free space refractive index n₁ (e.g., 1.0). Grating coupler 620 may be, for example, a Bragg grating or a surface-relief grating.

Display light 640 may be coupled into waveguide 610 by, for example, input coupler 430 of FIG. 4 or other couplers (e.g., a prism or slanted surface) described above. Display light 640 may propagate within waveguide 610 through, for example, total internal reflection. When display light 640 reaches grating coupler 620, display light 640 may be diffracted by grating coupler 620 into, for example, a 0^{th} order diffraction (i.e., reflection) light 642 and a −1st order diffraction light 644. The 0^{th} order diffraction may propagate within waveguide 610, and may be reflected by the bottom surface of waveguide 610 towards grating coupler 620 at a different location. The −1st order diffraction light 644 may be coupled (e.g., refracted) out of waveguide 610 towards the user's eye, because a total internal reflection condition may not be met at the bottom surface of waveguide 610 due to the diffraction angle.

External light 630 may also be diffracted by grating coupler 620 into, for example, a 0^{th} order diffraction light 632 and a −1st order diffraction light 634. Both the 0^{th} order diffraction light 632 and the −1st order diffraction light 634 may be refracted out of waveguide 610 towards the user's eye. Thus, grating coupler 620 may act as an input coupler for coupling external light 630 into waveguide 610, and may also act as an output coupler for coupling display light 640 out of waveguide 610. As such, grating coupler 620 may act as a combiner for combining external light 630 and display light 640. In general, the diffraction efficiency of grating coupler 620 (e.g., a surface-relief grating coupler) for external light 630 (i.e., transmissive diffraction) and the diffraction efficiency of grating coupler 620 for display light 640 (i.e., reflective diffraction) may be similar or comparable.

In order to diffract light at a desired direction towards the user's eye and to achieve a desired diffraction efficiency for certain diffraction orders, grating coupler 620 may include a blazed or slanted grating, such as a slanted Bragg grating or surface-relief grating, where the grating ridges and grooves may be tilted relative to the surface normal of grating coupler 620 or waveguide 610.

FIG. 7 illustrates an example of a slanted grating 720 in a waveguide display 700 according to certain embodiments. Slanted grating 720 may be an example of input coupler 430, output couplers 440, or grating coupler 620. Waveguide display 700 may include slanted grating 720 on a waveguide 710, such as substrate 420 or waveguide 610. Slanted grating 720 may act as a grating coupler for couple light into or out of waveguide 710. In some embodiments, slanted grating 720 may include a one-dimensional periodic structure with a period p. For example, slanted grating 720 may include a plurality of ridges 722 and grooves 724 between ridges 722. Each period of slanted grating 720 may include a ridge 722 and a groove 724, which may be an air gap or a region filled with a material with a refractive index n_{g2}. The ratio between the width d of a ridge 722 and the grating period p may be referred to as duty cycle. Slanted grating 720 may have a duty cycle ranging, for example, from about 10% to about 90% or greater. In some embodiments, the duty cycle may vary from period to period. In some embodiments, the period p of the slanted grating may vary from one area to another on slanted grating 720, or may vary from one period to another (i.e., chirped) on slanted grating 720.

Ridges 722 may be made of a material with a refractive index of n_{g1}, such as silicon containing materials (e.g., SiO₂, Si₃N₄, SiC, SiOₓN_{y}, or amorphous silicon), organic materials (e.g., spin on carbon (SOC) or amorphous carbon layer (ACL) or diamond like carbon (DLC)), or inorganic metal oxide layers (e.g., TiOₓ, AlOₓ, TaOₓ, HfOₓ, etc.). Each ridge 722 may include a leading edge 730 with a slant angel α and a trailing edge 740 with a slant angle β. In some embodiments, leading edge 730 and trailing edge 740 of each ridge 722 may be parallel to each other. In other words, slant angle α is approximately equal to slant angle β. In some embodiments, slant angle α may be different from slant angle β. In some embodiments, slant angle α may be approximately equal to slant angle β. For example, the difference between slant angle α and slant angle β may be less than 20%, 10%, 6%, 1%, or less. In some embodiments, slant angle α and slant angle β may range from, for example, about 30° or less to about 70% or larger.

In some implementations, grooves 724 between the ridges 722 may be over-coated or filled with a material having a refractive index n_{g2} higher or lower than the refractive index of the material of ridges 722. For example, in some embodiments, a high refractive index material, such as Hafnia, Titania, Tantalum oxide, Tungsten oxide, Zirconium oxide, Gallium sulfide, Gallium nitride, Gallium phosphide, silicon, and a high refractive index polymer, may be used to fill grooves 724. In some embodiments, a low refractive index material, such as silicon oxide, alumina, porous silica, or fluorinated low index monomer (or polymer), may be used to fill grooves 724. As a result, the difference between the refractive index of the ridges and the refractive index of the grooves may be greater than 0.1, 0.2, 0.3, 0.5, 1.0, or higher.

The user experience with an artificial reality system may depend on several optical characteristics of the artificial reality system, such as the field of view (FOV), image quality (e.g., resolution), size of the eye box of the system (to accommodate for eye and/or head movement), the distance of eye relief, optical bandwidth, and brightness of the displayed image. In general, the FOV and the eye box need to be as large as possible, the optical bandwidth needs to cover the visible band, and the brightness of the displayed image needs to be high enough (especially for optical see-through AR systems).

In a waveguide-based near-eye display, the output area of the display may be much larger than the size of the eyebox of the near-eye display system. The portion of light that may reach a user's eyes may depend on the ratio between the size of the eyebox and the output area of the display, which, in some cases, may be less than 10% for a certain eye relief and field of view. In order to achieve a desired brightness of the displayed image perceived by user's eyes, the display light from the projector or the light source may need to be increased significantly, which may increase the power consumption and cause some safety concerns.

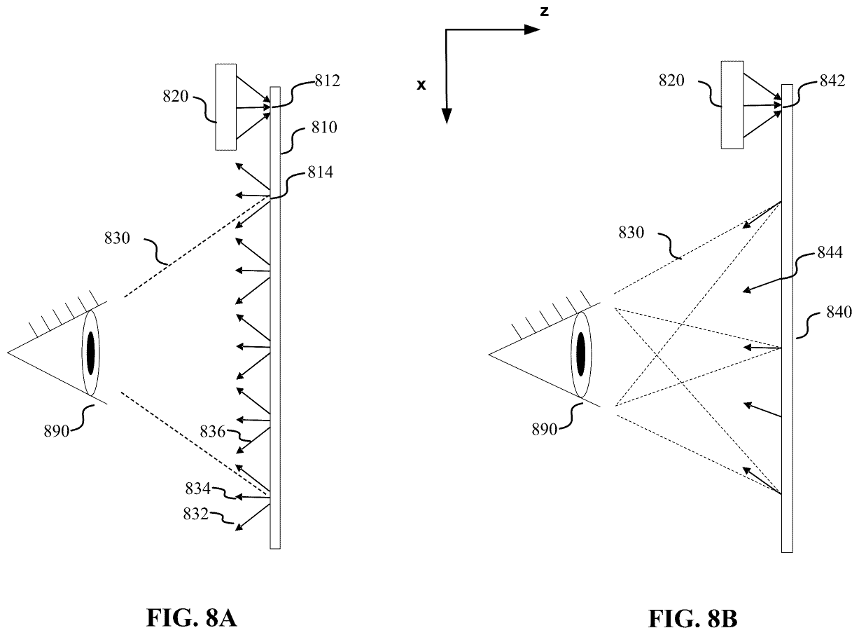

FIG. 8A illustrates an example of a waveguide-based near-eye display where display light for all fields of view is substantially uniformly output from different regions of a waveguide display 810. The near-eye display may include a projector 820 and waveguide display 810. Projector 820 may be similar to projector 410 and may include a light source or image source similar to light source or image source 412 and projector optics similar to projector optics 414. Waveguide display 810 may include a waveguide (e.g., a substrate), one or more input couplers 812, and one or more output couplers 814. Input couplers 812 may be configured to couple display light from different fields of view (or viewing angles) into the waveguide, and output couplers 814 may be configured to couple display light out of the waveguide. The input and output couplers may include, for example, slanted surface-relief gratings or volume Bragg gratings. In the example shown in FIG. 8, output coupler 814 may have similar grating parameters across the full region of the output coupler other than parameters that may be varied to adjust the coupling efficiency for more uniform output light. Thus, the display light may be partially coupled out of the waveguide at different regions of waveguide display 810 in a similar manner as shown in FIG. 8A, where display light from all fields of view of the near-eye display may be partially coupled out of the waveguide at any given region of waveguide display 810.

As also shown in FIG. 8A, the near-eye display system may have an eyebox at a certain eyebox position 890 and having a limited size and thus a limited field of view 830. As such, not all light coupled out of the waveguide in waveguide display 810 may reach the eyebox at eyebox position 890. For example, display light 832, 834, and 836 from waveguide display 810 may not reach the eyebox at eyebox position 890, and thus may not be received by the user's eyes, which may result in significant loss of the optical power from projector 820.

In certain embodiments, an optical coupler (e.g., a slanted surface-relief grating) for a waveguide-based display may include a grating coupler that includes multiple regions (or multiple multiplexed grating), where different regions of the grating coupler may have different angular selectivity characteristics (e.g., constructive interference conditions) for the incident display light such that, at any region of the waveguide-based display, diffraction light that would not eventually reach user's eyes may be suppressed (i.e., may not be diffracted by the grating coupler so as to be coupled into or out of the waveguide and thus may continue to propagate within the waveguide), while light that may eventually reach the user's eyes may be diffracted by the grating coupler and be coupled into or out of the waveguide.

FIG. 8B illustrates an example of a waveguide-based near-eye display where display light may be coupled out of a waveguide display 840 at different angles in different regions of the waveguide display according to certain embodiments. Waveguide display 840 may include a waveguide (e.g., a substrate), one or more input couplers 842, and one or more output couplers 844. Input couplers 842 may be configured to couple display light from different fields of view (e.g., viewing angles) into the waveguide, and output couplers 844 may be configured to couple display light out of the waveguide. The input and output couplers may include, for example, slanted surface-relief gratings or other types of gratings or reflectors. The output couplers may have different grating parameters and thus different angular selectivity characteristics at different regions of the output couplers. Thus, at each region of the output couplers, only display light that would propagate in a certain angular range towards the eyebox at eyebox position 890 of the near-eye display may be coupled out of the waveguide, while other display light may not meet the angular selectivity condition at the region and thus may not be coupled out of the waveguide. In some embodiments, the input couplers may also have different grating parameters and thus different angular selectivity characteristics at different regions of the input couplers, and thus, at each region of an input coupler, only display light from a respective field of view may be coupled into the waveguide. As a result, most of the display light coupled into the waveguide and propagating in the waveguide can be efficiently sent to the eyebox, thus improving the power efficiency of the waveguide-based near-eye display system.

The refractive index modulation of a slanted surface-relief grating, and other parameters of the slanted surface-relief grating, such as the grating period, the slant angle, the duty cycle, the depth, and the like, may be configured to selectively diffract incident light within a certain incident angular range (e.g., FOV) and/or a certain wavelength band at certain diffraction directions (e.g., within an angular range shown by field of view 830). For example, when the refractive index modulation is large (e.g., >0.2), a large angular bandwidth (e.g., >10°) may be achieved at the output couplers to provide a sufficiently large eyebox for the waveguide-based near-eye display system.

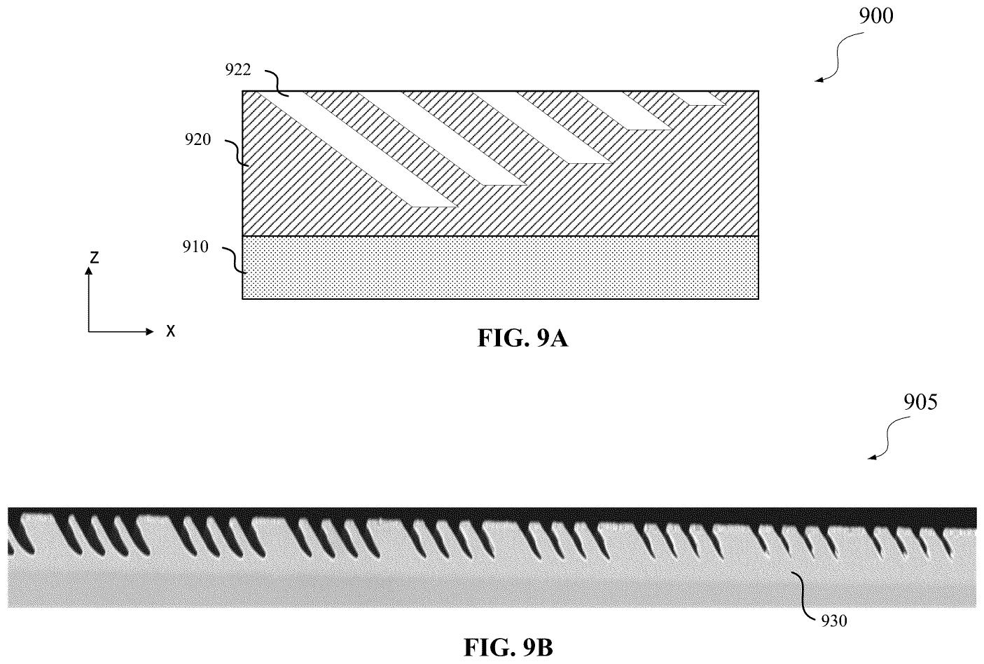

FIG. 9A illustrates an example of a slanted grating 900 with variable etch depths according to certain embodiments. Slanted grating 900 may include a substrate 910 (e.g., a glass substrate) and a grating layer 920 (e.g., a dielectric or polymer layer) formed on substrate 910. A plurality of grating grooves 922 may be etched or otherwise formed (e.g., imprinted) in grating layer 920. Grating grooves 922 may have non-uniform depths, widths, and/or separations. As such, slanted grating 900 may have variable grating periods, depths, and/or duty cycles.

FIG. 9B illustrates an example of a slanted grating 905 with variable etch depths and duty cycles according to certain embodiments. In the example shown in FIG. 9B, slanted grating 905 may be etched in a dielectric layer 930, which may have a refractive index, for example, between about 1.46 and about 2.4. As illustrated, slanted grating 905 may have different etch depths and duty cycles at different regions. The grating period may also be different at the different regions. As such, different regions of slanted grating 905 may have different desire diffraction characteristics as described above with respect to, for example, FIG. 8B.

The surface-relief gratings with parameters and configurations (e.g., duty cycles, depths, or refractive index modulations) varying over the regions of the gratings described above and other surface-relief gratings (e.g., gratings used for eye-tracking) may be fabricated using many different nanofabrication techniques. The nanofabrication techniques generally include a patterning process and a post-patterning (e.g., over-coating) process. The patterning process may be used to form slanted ridges or grooves of the slanted grating. There may be many different nanofabrication techniques for forming the slanted ridges. For example, in some implementations, the slanted grating may be fabricated using lithography techniques including slanted etching using ion beam plasma etching. In some implementations, the slanted grating may be fabricated using nanoimprint lithography (NIL) molding techniques, where a master mold including slanted structures may be fabricated using, for example, slanted etching techniques, and may then be used to mold slanted gratings or different generations of soft stamps for nanoimprinting. The post-patterning process may be used to over-coat the slanted ridges and/or to fill the gaps between the slanted ridges with a material having a different refractive index than the slanted ridges. The post-patterning process (e.g., overcoating and planarization) may be independent from the patterning process.

In an NIL molding process, a substrate (e.g., a waveguide) may be coated with a NIL resin layer. The NIL resin layer may include, for example, a butyl-acrylate-based resin doped with a sol-gel precursor (e.g., titanium butoxide), a monomer containing a reactive functional group for subsequent infusion processes (such as acrylic acid), and/or high refractive index nanoparticles (e.g., titanium oxide, zirconium oxide, hafnium oxide, tungsten oxide, zinc tellurium, or gallium phosphide). In some embodiments, the NIL resin layer may include polydimethylsiloxane (PDMS) or another silicone elastomer or silicon-based organic polymer. The NIL resin layer may be deposited on the substrate by, for example, spin-coating, lamination, or inkjet printing. A NIL mold with a nanostructure formed thereon may be pressed against the NIL resin layer and the substrate for molding a nanostructure in the NIL resin layer. The NIL resin layer may be cured subsequently (e.g., crosslinked) using heat and/or ultraviolet (UV) light. After the curing, the NIL mold may be detached from the NIL resin layer and the substrate. After the NIL mold is detached from the NIL resin layer and the substrate, a nanostructure (e.g., a slanted grating) that is complementary to the nanostructure in the NIL mold may be formed in the NIL resin layer on the substrate.

In some embodiments, a master NIL mold (e.g., a hard mold including a rigid material, such as Si, SiO₂, Si₃N₄, or a metal) may be fabricated first using, for example, slanted etching, micromachining, or 3-D printing. A soft stamp may be fabricated using the master NIL mold, and the soft stamp may then be used as the working stamp to fabricate the slanted grating or may be used to fabricate a next generation soft stamp. In such a process, the slanted grating structure in the master NIL mold may be similar to the slanted grating of the grating coupler for the waveguide display, and the slanted grating structure on the soft stamp may be complementary to the slanted grating structure in the master NIL mold and the slanted grating of the grating coupler for the waveguide display. Compared with a hard stamp or hard mold, a soft stamp may offer more flexibility during the molding and demolding processes.

The grating may be fabricated by nanoimprinting or etching may be over-coated with a material having a refractive index different from the slanted grating (e.g., the imprint resin layer or the substrate). The overcoat material may be substantially transparent to visible light. Depending on the applications, the overcoat material may have a refractive index higher or lower than the refractive index of the material forming the grating ridges. In some embodiments, the material forming the grating ridges may include amorphous silicon, silicon oxide, silicon nitride, silicon carbide, silicon oxynitride (SiOₓN_{y}), spin on carbon (SOC), amorphous carbon, diamond like carbon (DLC), titanium oxide, aluminum oxide, tantalum oxide, or hafnium oxide. In some embodiments, a high refractive index material, such as hafnium oxide, titanium oxide, tantalum oxide, tungsten oxide, zirconium oxide, gallium sulfide, gallium nitride, gallium phosphide, silicon, silicon nitride, or a high refractive index polymer, may be used to fill the grating grooves. In some embodiments, a low refractive index material, such as silicon oxide, alumina, porous silica, or fluorinated low index monomer (or polymer), may be used to fill the grating grooves. As a result, the difference between the refractive index of the grating ridges and the refractive index of the grating grooves filled with the overcoat material may be greater than about 0.01, greater than about 0.05, greater than about 0.1, greater than about 0.2, greater than 0.3, greater than about 0.5, greater than about 1.0, or higher.

Techniques for applying the overcoat layer on a surface-relief grating may include, for example, spin coating techniques. Generally, spin-coating techniques may work well to overcoat a relatively flat surface. However, it may be challenging to achieve a uniform overcoat layer when the surface to be overcoated includes some surface-relief structures (e.g., surface-relief gratings) formed thereon, and it may be even more difficult to achieve a uniform overcoat layer when the surface-relief structures are non-uniform across the surface, or when some surfaces are shadowed by other surfaces and/or structures. For example, the top surface of the overcoat layer may not be flat because the spin-on material may follow the topography of the underlying surface-relief structures, which may have varying slant angles, duty cycles, depths, and the like. As such, the top surface of the overcoat layer at grating grooves may be lower than the top surface of the overcoat layer at grating ridges. The uneven surface of the overcoat layer may degrade the performance of the surface-relief grating, such as causing stray light, reducing the coupling efficiency, increasing display leakage, and the like. The resultant thickness of the overcoat layer on the surface-relief structures using spin-coating techniques may also vary across the surface due to the varying slant angles, duty cycles, depths, grating periods, and the like. In many artificial reality applications, it may be desirable to precisely control the thickness and the surface roughness of the overcoat layer to improve the performance of the surface-relief grating and the display system. For example, it may be desirable that the thickness of the overburden of the overcoat layer (e.g., the portion of the overcoat layer on top of the grating ridges) is less than about 20 nm or thinner, and the surface peak-to-valley height is less than about 5 nm.

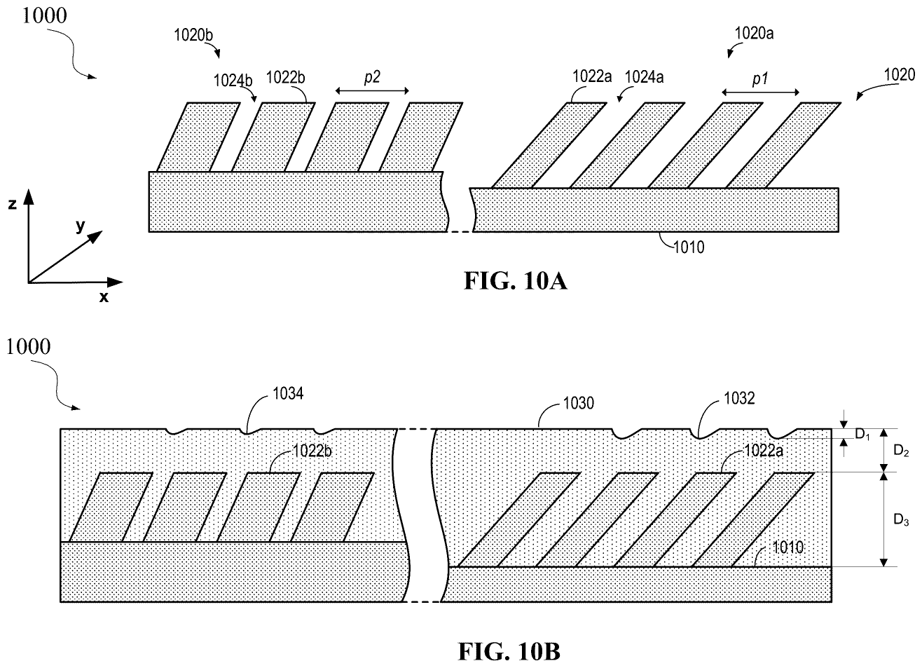

FIG. 10A illustrates an example of a slanted surface-relief grating in a waveguide display 1000 according to certain embodiments. Waveguide display 1000 may include slanted surface-relief structures, such as slanted surface-relief gratings 1020 on a substrate 1010 (e.g., a waveguide). Slanted surface-relief gratings 1020 may have sub-wavelength grating periods, large grating ridge heights (e.g., a few hundred nanometers or higher), and a large duty-cycle range (e.g., within about 10% and about 90%). As discussed above and also shown in FIG. 10A, the configuration of the slanted surface-relief gratings 1020 may vary across substrate 1010 so as to increase the coupling efficiency of the light to user's eyes. For example, some slanted gratings 1020a may include a period p₁ that may be different from the period p₂ of other slanted gratings 1020b. The heights of ridges 1022a and 1022b, the depths of grooves 1024a and 1024b, and the slant angles of the leading edges and the trailing edges of ridges 1022a and 1022b may also vary. The widths of ridges 1022a and 1022b and/or the widths of grooves 1024a and 1024b may vary as well, leading to varied duty cycles of slanted gratings 1020a and 1020b. The varied configuration of slanted surface-relief gratings 1020 may pose additional challenges to overcoat slanted surface-relief gratings 1020 uniformly and/or to form a substantially planar top surface of the overcoat layer.

FIG. 10B illustrates slanted surface-relief grating 1020 of FIG. 10A with an overcoat layer 1030 formed thereon. Due to the different grating parameters at different regions of slanted surface-relief grating 1020, overcoat layer 1030 formed using other techniques may not have a flat top surface. The depth D₁ of surface recesses 1032 and 1034 may vary depending on the structure of the slanted surface-relief gratings, such as the duty cycles of the slanted gratings, the width of the ridges and/or the grooves, the slant angles of the leading and trailing edges of the ridges, the depths D₃ of the grating grooves, and the like. For example, regions of slanted surface-relief grating 1020 having a low etch depth and/or having a large duty cycle (and thus shallow and/or narrow grating grooves) may have a lower surface peak-to-valley height as shown by surface recesses 1034, whereas regions of slanted surface-relief grating 1020 having a high etch depth and/or having a small duty cycle (and thus deep and/or wide grating grooves) may have a higher surface peak-to-valley height as shown by surface recesses 1032. In some embodiments, the overburden thickness D₂ may also vary across regions of slanted surface-relief grating 1020. For example, the overburden thickness D₂ in regions where more overcoat material may be needed to fill the grating grooves may be lower than the overburden thickness D₂ in regions where less overcoat material may be needed to fill the grating grooves. In some implementations, the depths D₃ of the grating grooves may be greater than or about 100 nm, greater than or about 150 nm, greater than or about 200 nm, greater than or about 250 nm, greater than or about 300 nm, or greater. In some implementations, planarization techniques, such as slanted etching, atomic layer deposition (ALD), and the like, may be used to achieve a relatively flat top surface on the overcoat layer.

As described above, in a waveguide-based near-eye display system, display light of projected images may be coupled into a waveguide, propagate within the waveguide, and be coupled out of the waveguide at different locations to replicate exit pupils and expand the eyebox. In some implementations, two or more one-dimensional or two-dimensional gratings may be used to expand the eyebox in two dimensions. For example, an input grating, a fold grating, and an output grating may be used to expand the pupil to fill an eyebox. Each of the input grating, fold grating, and output grating may have its own periodicity and tilt angle (and thus its own grating vector). The sum of the grating vectors (k-vectors) of the three gratings may be equal to 0 for angle preservation such that the angles of the input beam to the waveguide and the angles of the output beam from the waveguide may be about the same.

FIG. 11A illustrates an example of an optical see-through augmented reality system including a waveguide display 1100 and surface-relief gratings for exit pupil expansion according to certain embodiments. Waveguide display 1100 may include a substrate 1110 (e.g., a waveguide). Substrate 1110 may be transparent to visible light and may include, for example, a glass, quartz, plastic, polymer, PMMA, ceramic, Si₃N₄, SiC, or crystal substrate. Substrate 1110 may be a flat substrate or a curved substrate. Substrate 1110 may include two opposing broadside surfaces that include a first surface 1112 and a second surface 1114, and multiple sidewalls surfaces 1116 that may be perpendicular to the broadside surfaces. Display light may be coupled into substrate 1110 by an input coupler 1120, and may be reflected by first surface 1112 and second surface 1114 through total internal reflection, such that the display light may propagate within substrate 1110. Input coupler 1120 may include a grating, a refractive coupler (e.g., a wedge or a prism), or a reflective coupler (e.g., a reflective surface having a slant angle with respect to substrate 1110). For example, in one embodiment, input coupler 1120 may include a prism that may couple display light of different colors into substrate 1110 at a same refraction angle. In another example, input coupler 1120 may include a grating coupler that may diffract light of different colors into substrate 1110 at different directions. Input coupler 1120 may have a coupling efficiency of greater than 10%, 20%, 30%, 50%, 75%, 120%, or higher for visible light.

Waveguide display 1100 may also include a first output grating 1130 and a second output grating 1140 positioned on one or two surfaces (e.g., first surface 1112 and second surface 1114) of substrate 1110 for expanding incident display light beam in two dimensions in order to fill an eyebox with the display light. First output grating 1130 may be configured to expand at least a portion of the display light beam along one direction, such as approximately in the x direction. Display light coupled into substrate 1110 may propagate in a direction shown by a line 1132. While the display light propagates within substrate 1110 along a direction shown by line 1132, a portion of the display light may be diffracted by a region of first output grating 1130 towards second output grating 1140 as shown by a line 1134 each time the display light propagating within substrate 1110 reaches first output grating 1130. Second output grating 1140 may then expand the display light from first output grating 1130 in a different direction (e.g., approximately in the y direction) by diffracting a portion of the display light from an exit region 1150 to the eyebox each time the display light propagating within substrate 1110 reaches second output grating 1140.

FIG. 11B illustrates an example of an eye box including two-dimensional replicated exit pupils. FIG. 11B shows that a single input pupil 1105 may be replicated by first output grating 1130 and second output grating 1140 to form an aggregated exit pupil 1160 that includes a two-dimensional array of individual exit pupils 1162. For example, the exit pupil may be replicated in approximately the x direction by first output grating 1130 and in approximately the y direction by second output grating 1140. As described above, output light from individual exit pupils 1162 and propagating in a same direction may be focused onto a same location in the retina of the user's eye. Thus, a single image may be formed by the user's eye from the output light in the two-dimensional array of individual exit pupils 1162.

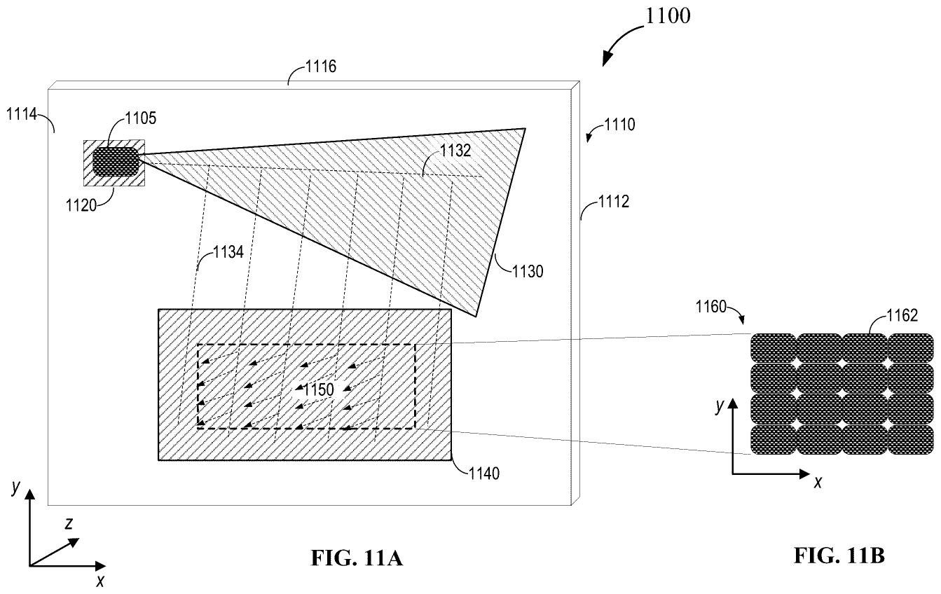

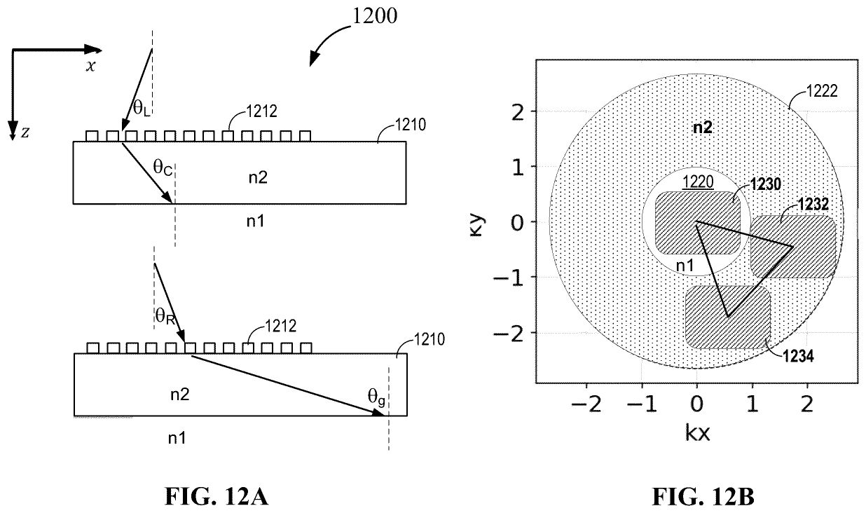

FIG. 12A illustrates an example of a waveguide display 1200 including a waveguide 1210 and a grating coupler 1212 formed on waveguide 1210. Waveguide 1210 may include a substrate that is transparent to visible light and may have a refractive index n2, where the medium (e.g., air) surrounding waveguide 1210 may have a refractive index about n1 (e.g., about 1.0). Grating coupler 1212 may be an SRG, VBG, PVH, PDLC, metasurface, and the like.

As shown in FIG. 12A, waveguide 1210 may only guide light having certain propagation directions within waveguide through total internal reflections. The minimum angle of incidence of the guided light at the top or bottom surface of waveguide 1210 may be the critical angle θ_{c} at the interface between waveguide 1210 and the surrounding medium (e.g., air). Display light for the left field of view and having an angle of incidence θ_{L}, may be diffracted by grating coupler 1212 to propagate within waveguide 1210 at critical angle θ_{c}. Display light for the left field of view having angles of incidence greater than θ_{L} may be diffracted by grating coupler 1212 into waveguide 1210 and incident on a surface of waveguide 1210 at angles of incidence less than the critical angle θ_{c}, and thus may leak out of the waveguide because the total-internal-reflection condition is not met.

As also shown in FIG. 12A, in-coupled display light that is incident on a surface of waveguide 1210 at angles of incidence greater than a grazing angle θ_{g} may become evanescent, and thus may not be guided by waveguide 1210. Display light for the right field of view and having an angle of incidence θ_{R} may be diffracted by grating coupler 1212 to propagate within waveguide 1210 at grazing angle θ_{g}. Display light for the right field of view and having angles of incidence greater than OR may be diffracted by grating coupler 1212 into waveguide 1210 and incident on a surface of waveguide 1210 at angles of incidence greater than the grazing angle θ_{g}, and thus may become evanescent and may not be guided by waveguide 1210. Therefore, the field of view of waveguide display 1200 may be limited to between θ_{L}, and θ_{R}.

FIG. 12B illustrates wave vectors (k-vectors) of light that may be guided by waveguide 1210 of FIG. 12A. In k-space, light propagating at different angles may be represented by different wave vectors. Wave vectors of display light supported by a waveguide may be bounded by a circle 1220 corresponding to the critical angle for total internal reflection (TIR), and a circle 1222 corresponding to the grazing angle. For light with wave vectors outside of circle 1222, the light may become evanescent. Wave vectors within circle 1220 may represent light that may leak out of the waveguide because the total-internal-reflection condition is not met. Thus, the ring between circle 1220 and circle 1222 may represent the wave vectors of light that can be guided by the waveguide and can propagate within the waveguide through TIR. For waveguides with higher refractive indices, the critical angle (and circle 1220) may be smaller and the grazing angle (and circle 1222) may be larger, and thus the angular range of the display light that may be guided by the waveguide may be larger. Waveguides with large refractive indices may be more expensive and more difficult to fabricate, and may not be able to achieve the desired full FOV of the waveguide display.

In one example shown in FIG. 12B, wave vectors of an input display light frustum (e.g., within a FOV of ±30°×±20° or larger) may be represented by a region 1230 in the k-space. The light frustum of the portion of the input display light frustum diffracted by an input coupler and coupled into the substrate (e.g., waveguide 1210) may be represented by a region 1232 in the k-space. The light frustum of the portion of the display light diffracted by the first output grating (or fold grating) may be represented by a region 1234 in the k-space. The wave vectors of the light frustum of the portion of the display light diffracted by the second output grating may be in region 1230, which is outside of the ring-shaped region, and thus the light diffracted by the second output grating may not be supported by the substrate and may leak out of the substrate.

In grating-based waveguide displays, display light of different colors or from different FOVs may be directed to the eyebox at different densities, and may also form ghost images on the retina of user's eyes. For example, two light beams having different colors (e.g., red and blue) and the same incidence angle (e.g., from a same field of view) may be diffracted by an input grating into the waveguide at different directions, where the light beam having a shorter wavelength (e.g., blue light) may have a smaller diffraction angle. Two light beams having the same color but different incidence angles may also be diffracted into the waveguide at different directions by the input grating. Due to the different propagation directions, the in-coupled light beams may be replicated for different numbers of times at different densities. As such, display light of different colors or from different FOVs may be directed to the eyebox at different densities, which may degrade the intensity uniformity of the display, and may, in some cases, form ghost images on the retina of user's eyes.

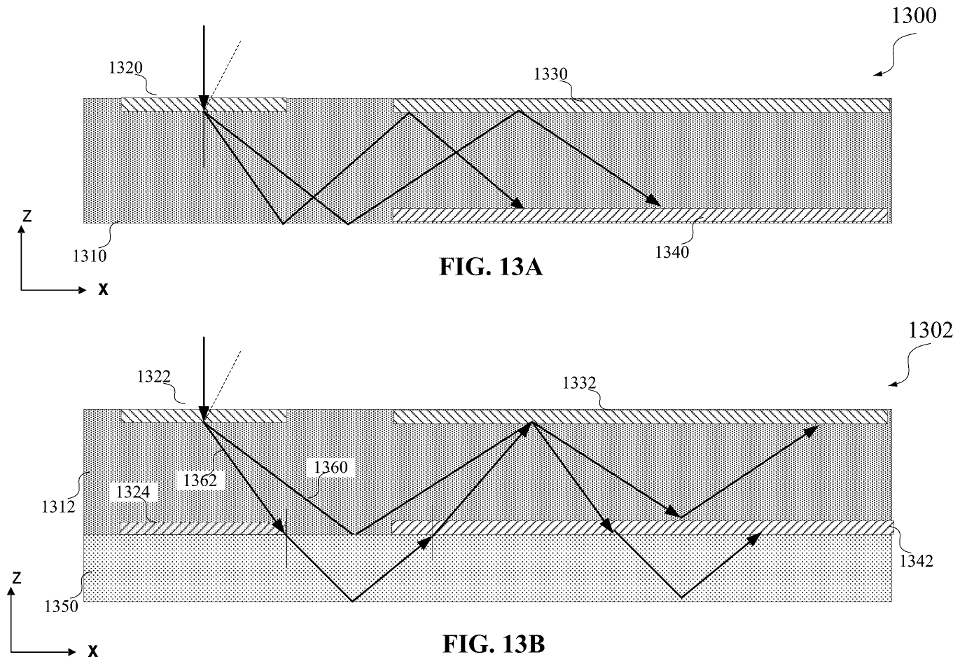

FIG. 13A illustrates an example of a waveguide display 1300. Waveguide display 1300 may include a substrate 1310. Substrate 1310 may include, for example, glass, silicon, silicon nitride, silicon carbide (SiC), LiNbO₃, TiO₂, CVD diamond, ZnS, or any other suitable material. An input grating 1320 and one or more output gratings 1330 and 1340 may be etched in substrate 1310 or in a grating material layer formed on substrate 1310. Input grating 1320 and output gratings 1330 and 1340 may include slanted or vertical surface-relief gratings, and may include an overcoat layer filling the grating grooves as described above. Output gratings 1330 and 1340 may be etched on opposite surfaces of substrate 1310. In some embodiments, only one output grating 1330 or 1340 may be used. As described above, input grating 1320 may couple display light of different colors (e.g., red, green, and blue) from different view angles (or within different fields of view (FOVs)) into substrate 1310, which may guide the in-coupled display light through total internal reflection. A portion of the in-coupled display light propagating within substrate 1310 may be coupled out of substrate 1310 towards an eyebox of waveguide display 1300 by output grating 1330 or 1340 each time the in-coupled display light reaches output grating 1330 or 1340.

As described above, to satisfy the grating equation, a diffraction grating may diffract incident light of different colors (wavelengths) and/or from different view angles to different diffraction angles. For example, in the example illustrated in FIG. 13A, two light beams having different colors (e.g., red and blue) and the same incidence angle (e.g., about) 0° may be diffracted by input grating 1320 to different directions within substrate 1310. More specifically, the light beam having a shorter wavelength (e.g., blue light) may have a smaller diffraction angle. Two light beams having the same color but different incidence angles may also be diffracted by input grating 1320 to two different directions within substrate 1310. Due to the different propagation directions, the two in-coupled light beams may reach the surfaces of substrate 1310 and be diffracted out of substrate 1310 after propagating different distances in the x direction. A light beam having a smaller angle with respect to the surface-normal direction of substrate 1310 may reach output grating 1330 or 1340 for a larger number of times than a light beam having a larger angle with respect to the surface-normal direction of substrate 1310. In addition, a grating may not have a flat diffraction efficiency for incident light of different colors or different incidence angle. For these reasons, display light of different colors or from different FOVs may be directed to the eyebox at different densities, and may form ghost images on the retina of user's eyes.

In some embodiments, to reduce the ghost images and improve the uniformity of the display for light of all colors and from all FOVs, a multi-layer waveguide may be used. The multi-layer waveguide may include multiple waveguide layers having appropriate refractive indices and thicknesses in a layer stack. In some embodiments, the multiple waveguide layers in the layer stack may have the highest refractive index at the center of the layer stack, and the refractive indices of the multiple waveguide layers may decrease from the center towards the two opposite sides of the layer stack. In some embodiments, the refractive indices of the multiple waveguide layers may decrease from one side toward the opposite side of the layer stack.

FIG. 13B illustrates an example of a multi-layer waveguide display 1302 according to certain embodiments. Multi-layer waveguide display 1302 may include a substrate 1312, an input grating 1322, and one or more output gratings 1332 and 1342, which may be similar to substrate 1310, input grating 1320, and one or more output gratings 1330 and 1340, respectively. Input gratings 1322 and 1324 and output gratings 1332 and 1342 may be vertical or slanted surface-relief gratings formed in substrate 1312 or a grating material layer on substrate 1312, and may include an overcoat layer filling the grating grooves as described above with respect to FIG. 7. Multi-layer waveguide display 1302 may also include a second waveguide layer 1350, which may be a thin layer (e.g., a few hundred micrometers, such as between about 100 μm and about 600 μm) of a transparent material having a lower refractive index than the refractive index of substrate 1312. For example, the difference between the refractive index of substrate 1312 and the refractive index of second waveguide layer 1350 may be about 0.01, 0.02, 0.05, 0.1, 0.2, 0.25, 0.3, or larger.

In the example shown in FIG. 13B, a first light beam 1360 (e.g., having a longer wavelength or from a larger view angle) may be coupled into substrate 1312 by input grating 1322 and may propagate within substrate 1312 with a large angle with respect to a surface-normal direction of substrate 1312. Therefore, first light beam 1360 may be reflected at the interface between substrate 1312 and second waveguide layer 1350 through total internal reflection, due to the large incidence angle and the large difference between the refractive indices of substrate 1312 and second waveguide layer 1350. A second light beam 1362 (e.g., having a shorter wavelength and/or from a smaller view angle) may be coupled into substrate 1312 by input grating 1322 and may propagate within substrate 1312 with a smaller angle with respect to the surface-normal direction of substrate 1312. Therefore, second light beam 1362 may not be reflected at the interface between substrate 1312 and second waveguide layer 1350 through total internal reflection, because the incidence angle may be smaller than the critical angle at the interface. Thus, second light beam 1362 may instead be refracted at the interface with a larger refraction angle into second waveguide layer 1350, and may then be reflected at the bottom surface of second waveguide layer 1350 through total internal reflection due to the increased incidence angle and the larger difference (e.g., about 0.5) between the refractive indices of second waveguide layer 1350 and air. Therefore, even though second light beam 1362 may have a smaller propagation angle with respect to the surface-normal direction of substrate 1312 than first light beam 1360, second light beam 1362 may travel a longer distance in the z direction before being reflected through total internal reflection, and thus may travel a similar distance in the x direction as first light beam 1360 before being reflected through total internal reflection. In this way, first light beam 1360 and second light beam 1362 may be diffracted by output grating 1332 or 1342 at about the same locations (or same interval) and for about the same number of times. The thicknesses and refractive indices of substrate 1312 and second waveguide layer 1350 may be selected based on the desired performance.

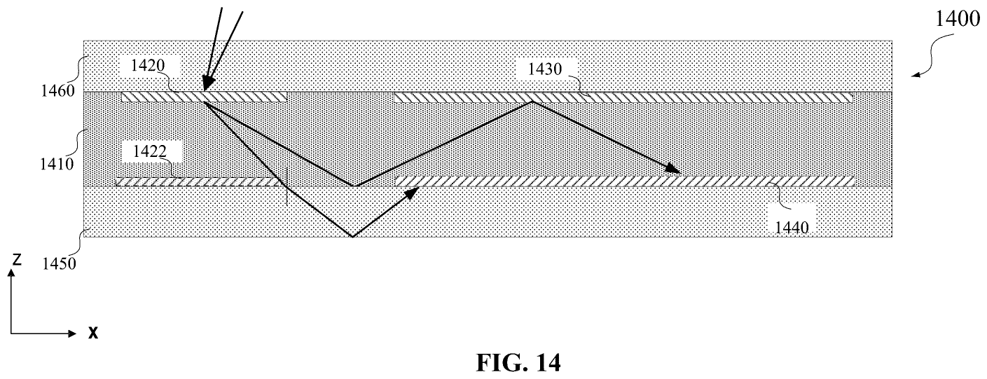

FIG. 14 illustrates an example of a multi-layer waveguide display 1400 according to certain embodiments. Multi-layer waveguide display 1400 may include a first waveguide layer 1410 that includes one or more input gratings 1420 and 1422 and one or more output gratings 1430 and 1440 formed thereon as in waveguide display 1300 and multi-layer waveguide display 1302 described above. First waveguide layer 1410 may include, for example, glass, silicon, silicon nitride, silicon carbide (SiC), LiNbO₃, TiO₂, CVD diamond, ZnS, and the like. Input gratings 1420 and 1422 and output gratings 1430 and 1440 may be slanted or vertical surface-relief gratings and may include an overcoat layer filling the grating grooves. In some embodiments, one or more of input gratings 1420 and 1422 and output gratings 1430 and 1440 may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

Multi-layer waveguide display 1400 may include a second waveguide layer 1450 and a third waveguide layer 1460 on opposing sides of first waveguide layer 1410. Second waveguide layer 1450 and third waveguide layer 1460 may each be a thin layer (e.g., a few hundred micrometers, such as between about 100 μm and about 600 μm) of a transparent material having a lower refractive index than the refractive index of first waveguide layer 1410. For example, the difference between the refractive index of first waveguide layer 1410 and the refractive index of second waveguide layer 1450 or third waveguide layer 1460 may be about 0.01, 0.02, 0.05, 0.1, 0.2, 0.25, 0.3, or larger. Multi-layer waveguide display 1400 may achieve a more uniform replication of light having different colors and/or from different FOVs as described above with respect to FIG. 6B and FIG. 13B. The thicknesses and the refractive indices of first waveguide layer 1410, second waveguide layer 1450, and third waveguide layer 1460 may be selected based on the desired performance.

In various embodiments, the multi-layer waveguide displays disclosed herein may include two or more waveguide layers, such as three, four, five, or more layers. In some embodiments, the low-index waveguide layers may be on a same side of the input and output gratings, and the refractive indices of the two or more waveguide layers may be the highest at one side of the layer stack and then gradually decrease towards the other side of the layer stack. In some embodiments, the low-index waveguide layers may be on opposing sides of the input and output gratings, and the refractive indices of the two or more waveguide layers may be the highest at the center of the layer stack and may gradually decrease towards two opposite sides of the layer stack. In some embodiments, the refractive index profile of the waveguide layer stack may not be symmetrical with respect to the center of the waveguide layer stack.

The multiple waveguide layers having different refractive indices and thicknesses (e.g., from about 100 to about 600 μm) may need to be flat and have a low total thickness variation (e.g., <1 μm) and a low surface roughness (e.g., with a root mean squared areal roughness less than about 1 nm). The multiple waveguide layers may need to have low transmissive haze. It may also be desirable that the multiple waveguide layers be made at low temperatures, such as at the room temperature. Thus, it can be challenging to fabricate the multiple waveguide layers on a substrate that has grating couplers etched thereon.

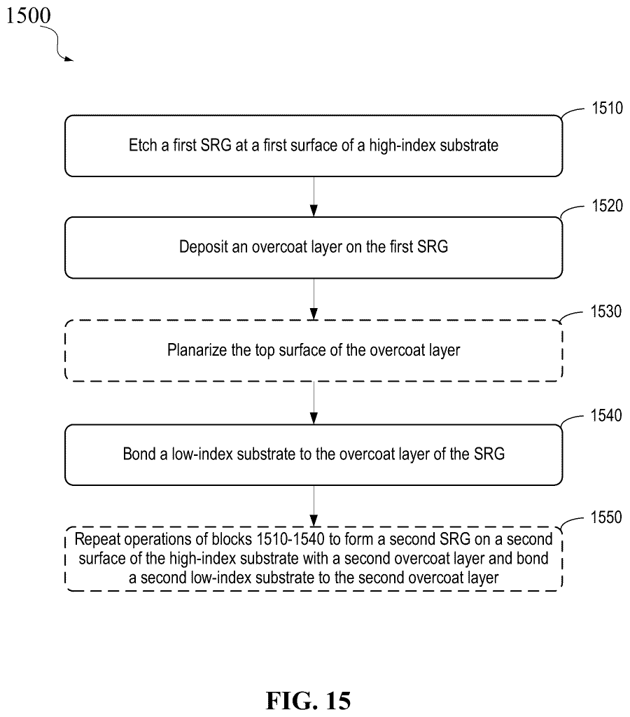

FIG. 15 includes a flowchart 1500 illustrating an example of a process of fabricating a waveguide display including a layered waveguide. Operations described in flowchart 1500 are for illustration purposes only and are not intended to be limiting. In various implementations, modifications may be made to flowchart 1500 to add additional operations, to omit some operations, or to change the order of the operations. The operations described in flowchart 1500 may be performed using, for example, one or more fabrication systems, such as a photolithography system, a dry or wet etching (e.g., ion beam etching (IBE), plasma etching (PE), or reactive ion etching (RIE)) system, an atomic layer deposition (ALD) system, a chemical vapor deposition (CVD) system, a physical vapor deposition (PVD) system, a nanoimprint system, and the like.

Operations in flowchart 1500 may include, at block 1510, etching one or more SRGs at a first surface of a high-index substrate, such as a SiC or LiNbO₃ substrate. The etching may be a dry etching process such as a plasma etching process using, for example, ion beams. The etching may be vertical or slanted. As described above, the etch rate of etching the high-index substrate using plasma may be low. At block 1520, an overcoat layer may be deposited on the one or more SRGs at the first surface of the high-index substrate. The overcoat layer may have a refractive index lower than the refractive index of the high-index substrate, and may be deposited on the one or more SRGs by, for example, spin coating, ALD, PVD, CVD, and the like. Optionally, at block 1530, the top surface of the overcoat layer may be planarized using, for example, slanted etching, chemical mechanical planarization (CMP), ALD, nanoimprinting, grayscale lithography, and the like. In some embodiments, the overcoat layer on top of the grating ridges of the SRGs may be thinned, for example, by etching or polishing, such that the overburden of the lower-index overcoating material on top of the grating ridges may be thin (ideally close to zero) and thus may not significantly reduce the efficiency of the waveguide display. A lower-index substrate may then be bonded to the overcoat layer of the SRG at the first side of the high-index substrate at block 1540 using, for example, optical clear adhesive (OCA) or fusion bonding. Optionally, at block 1550, options of blocks 1510-1540 may be repeated to form one or more SRGs at a second surface of the high-index substrate and bond a lower-index substrate to the second side of the high-index substrate to form a layered waveguide structure.

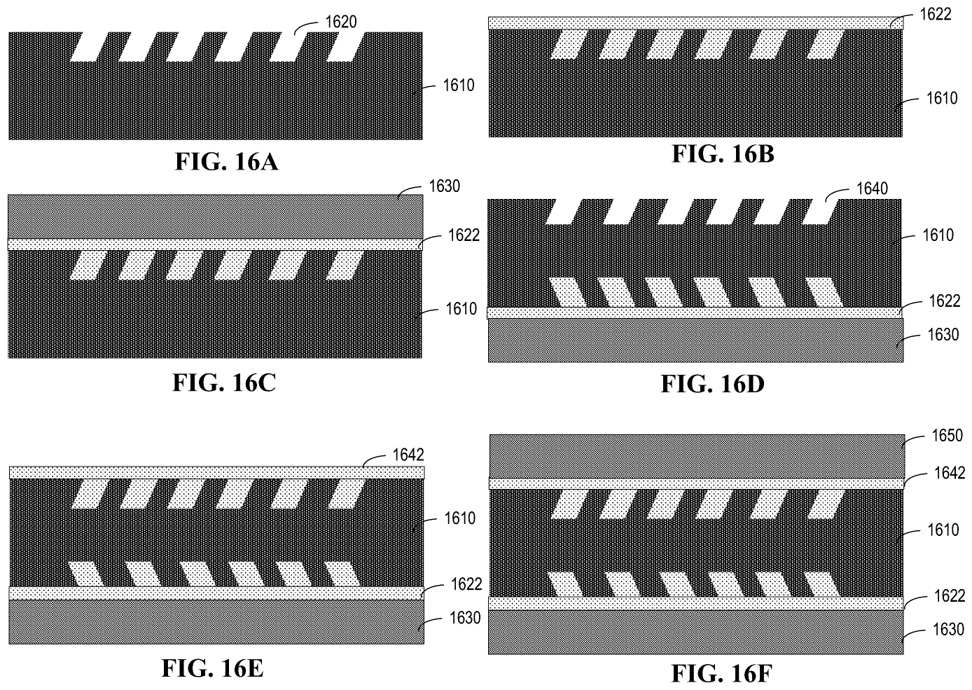

FIGS. 16A-16F illustrate an example of a process of fabricating a waveguide display including a layered waveguide. FIG. 16A shows a first SRG 1620 etched at a first surface of a high-index substrate 1610 (e.g., SiC or LN substrate) as described above, for example, with respect to block 1510. First SRG 1620 may be vertical or slanted, and may have a constant or variable grating period, a constant or variable etch depth, a constant or variable duty cycle, a constant or variable slant angle, or a combination thereof. As shown in FIG. 16B, an overcoat layer 1622 may be formed on first SRG 1620 to fill grating grooves of first SRG 1620 as described above, for example, with respect to block 1520. Overcoat layer 1622 may include a low-index material, such as SiO₂ or a resin. Overcoat layer 1622 may be deposited on first SRG 1620 by, for example, spin coating, inkjet printing, atomic layer deposition, and the like. A thin layer of the low-index material (overburden layer) may be on top of the grating ridges. In some cases, the top surface of overcoat layer 1622 may not be flat, and a planarization process (e.g., etching or polishing process) may be performed to planarize the top surface and/or at least partially remove the overburden layer. After the planarization of overcoat layer 1622, a first lower-index substrate 1630 (e.g., a glass substrate) may be bonded to overcoat layer 1622, as shown in FIG. 16C.

In some embodiments, a second SRG 1640 may be etched at a second surface of high-index substrate 1610 as shown in FIG. 16D. Second SRG 1640 may be vertical or slanted, and may have a constant or variable grating period, a constant or variable etch depth, a constant or variable duty cycle, a constant or variable slant angle, or a combination thereof. An overcoat layer 1642 may be deposited on second SRG 1640 to fill grating grooves of second SRG 1640 as shown in FIG. 16E. Overcoat layer 1642 may include a low-index material, such as SiO₂ or a resin. A thin layer of the low-index material (overburden layer) may be on top of the grating ridges. In some circumstances, the top surface of overcoat layer 1642 may not be flat, and a planarization process (e.g., etching or polishing process) may be performed to planarize the top surface and/or at least partially remove the overburden layer. After the planarization of overcoat layer 1642, a second lower-index substrate 1650 (e.g., a glass substrate) may be bonded to overcoat layer 1642, as shown in FIG. 16F, to form a layered waveguide including substrates of different refractive indices and buried SRGs.

As described above, even though it is desirable to use a waveguide with a high refractive index to improve, for example, the FOV of the waveguide display, it can be very difficult to fabricate SRGs in high-refractive index (high-index) substrates (e.g., SiC or lithium niobate) (LiNbO₃ or LN) using techniques other than plasma (e.g., ion beam) etching techniques. For example, it is difficult to fabricate index matched gratings on high-index substrates (e.g., with RI>2.0, such as LN) using nanoimprint lithography (NIL) techniques. Using dry etch (e.g., plasma etch) based techniques to etch SRGs in high-index substrates may use many processing steps, and may be expensive and time consuming (low productivity) due to certain properties (e.g., hardness) of the high-index materials and may also have more process variations. In addition, as shown in FIG. 16F, the overburden layer between high-index substrate 1610 and first lower-index substrate 1630 or second lower-index substrate 1650 may have a certain thickness, and a refractive index mismatch between high-index substrate 1610 and first lower-index substrate 1630 (or second lower-index substrate 1650) may be large. Therefore, there may be high optical loss caused by the overburden layer and the refractive index mismatch.

According to some embodiments, a waveguide display may have a layered waveguide structure that includes a high-index substrate and one or more surface-relief gratings formed on one or more low-index substrates using techniques such as NIL, where the one or more surface-relief gratings formed on one or more low-index substrates may be bonded to the high-index substrate by, for example, fusion bonding. The SRGs may be fabricated using NIL techniques that can achieve high productivity and high yield and thus can be less expensive. The SRGs may be filled and/or deposited with a layer of a material that has a refractive index matching the refractive index of the high-index substrate such that there may be a low optical loss due to refractive index mismatch between the deposited layer and the high-index substrate. In some embodiments, a layer of the same index-matching material may be deposited on the high-index substrate before the bonding such that the bonding may be direct bonding between layers of the same material and thus may be performed at close to room temperatures. The SRGs can be imprinted to have a very thin layer (e.g., with a thickness close to zero) between the SRGs and the low-index substrate, such that the overburden (between the SRG and the low-index substrate) after bonding to the high-index substrate can be low to reduce loss due to refractive index mismatch.

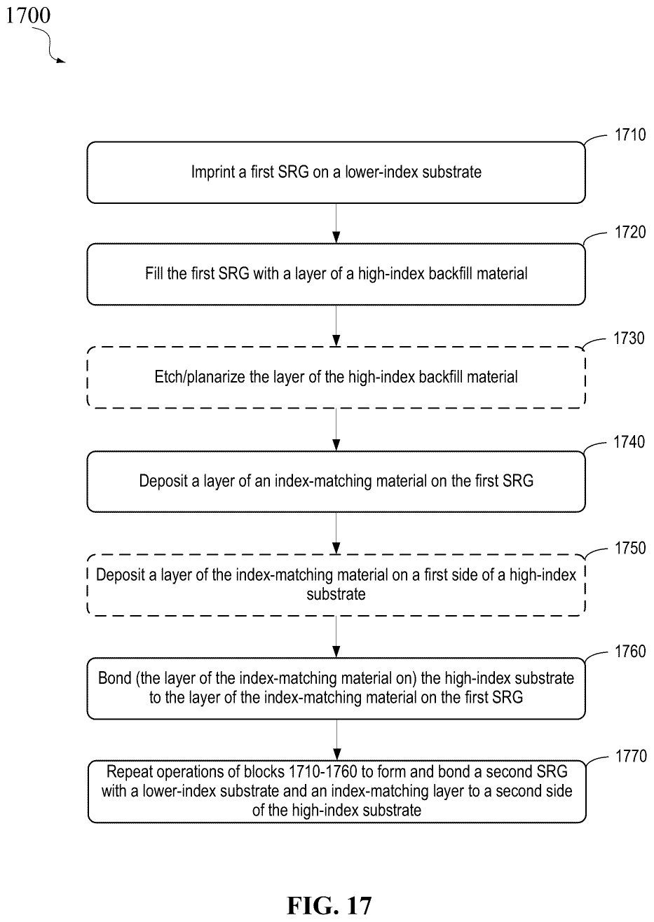

FIG. 17 includes a flowchart 1700 illustrates an example of a process of fabricating a waveguide display including a layered waveguide according to certain embodiments. The operations described in flowchart 1700 are for illustration purposes only and are not intended to be limiting. In various implementations, modifications may be made to flowchart 1700 to add additional operations, to omit some operations, or to change the order of the operations. The operations described in flowchart 1700 may be performed using, for example, one or more fabrication systems, such as a photolithography system, a nanoimprint lithography system, a dry or wet etching (e.g., ion beam etching (IBE), plasma etching (PE), or reactive ion etching (RIE)) system, an atomic layer deposition (ALD) system, a chemical vapor deposition (CVD) system, a physical vapor deposition (PVD) system, and the like.

Flowchart 1700 may include, at block 1710, imprinting a first SRG on a lower-index substrate, such as a glass substrate. The lower-index substrate may have a refractive index between about 1.5 and 2.0, such as about 1.7. The imprint material may have a refractive index in the range of about 1.4 to about 1.8. A layer of the imprint material may be deposited on the lower-index substrate and then imprinted using a stamp (e.g., a master mold or a soft stamp). The master mold may be fabricated by, for example, inkjet printing, 3-D printing, grayscale lithography, and the like. The imprinted material with the stamp may be cured and then the stamp may be removed to form the SRG in the imprint material layer deposited on the lower-index substrate as described above. The SRG may have a constant or variable grating period, a constant or variable etch depth, a constant or variable duty cycle, a constant or variable slant angle, or a combination thereof. For example, the slant angles of the grating ridges may be between about 0° and about 70° or larger, the depths of the grating grooves may vary and may be up to 500 nm or higher, the duty cycles of the SRG may vary between about 0.1 and about 0.9, and the grating periods of the SRG may vary between about 150 nm and about 700 nm.

At block 1720, the first SRG may be backfilled with a high-index backfill material. In some embodiments, the high-index backfill material may match the refractive index of a high-index substrate. As described above, the high-index substrate may have a refractive index greater than about 2.0, such as about 2.0 to about 2.7. For example, the high-index substrate may include SiN, SiC, LiNbO₃, TiO₂, CVD diamond, ZnS, and the like. The high-index backfill material may also have a refractive index greater than about 2.0, such as about 2.0 to about 2.7. For example, the high-index backfill material may include TiOₓ (e.g., with an RI about 2.3) or some other high-index metal oxides such as TaOₓ, ZrOₓ, and the like. The high-index backfill material may be deposited on the first SRG to fill the grating grooves using surface-conforming deposition techniques such as ALD, and may be deposited layer by layer such that the top surface of the high-index backfill material on the first SRG may be substantially flat and have a low surface roughness. In some embodiments, the first SRG may be pre-cleaned before depositing the high-index backfill material. The high-index backfill material may completely fill the grating grooves and may also be on top of the grating ridges. In some cases (e.g., when the grating duty cycle is small, the grating depth is high, the grating period is large, and/or the grating parameters have large variations across the first SRG), the top surface of the deposited high-index backfill material may include dips, ripples, or other surface roughness.

In some embodiments, at block 1730, the deposited high-index backfill material may optionally be etched or otherwise thinned to at least partially remove the deposited high-index backfill material on top of the grating ridges and/or planarize the top surface of the deposited high-index backfill material. The operations at block 1730 may include, for example, etching (e.g., wet or dry etching, vertical or slanted etching, etc.), CMP, grayscale lithography, or other processes that may be used to planarize and/or thin the layer of the deposited high-index backfill material. In some embodiments, a standard clean 1 (SC1 or RCA-1) process may be performed to clean the surface of the high-index backfill material.

In some embodiments, at block 1740, a layer of an index-matching material that matches the refractive index of the high-index substrate may be deposited on the backfilled first SRG to form an index-matching layer with a substantially planarized surface. In one example, the index-matching material may be the same as the high-index backfill material, such as TiOₓ, and may have a refractive index within about +0.05 from the refractive index of the high-index substrate. The thickness of the index-matching layer may be, for example, about 20 nm to about 20 μm, and may be deposited using, for example, a PVD process.

In some embodiments, at block 1750, a layer of the index-matching material (e.g., TiOₓ) may be deposited on a first side of a high-index substrate using, for example, a PVD process. The index-matching material deposited on the first side of the high-index substrate may facilitate the bonding between the index-matching layer on the SRG and the high-index substrate at a low temperature (e.g., around room temperature), such as between about room temperature and about 400° C. or lower, because the two material layers bonded together have the same material.

At block 1760, the high-index substrate may be bonded to the first SRG by bonding the layer of the index-matching material on the high-index substrate to the layer of the index-matching material on the first SRG. The bonding may include cleaning the surfaces of the bonding layers, and direct bonding the bonding layers using, for example, fusion bonding at a low temperature, such as between about room temperature and about 400° C. or lower.

At block 1770, operations of blocks 1710-1760 may be performed again to form and bond a second SRG nanoimprinted on a lower-index substrate and having an index-matching layer to a second side of the high-index substrate that may optionally be deposited with a layer of the index-matching material on the second side. In some embodiments, similar processes may be performed repeatedly to fabricate and bond one or more SRGs on one or more substrate layers to form a layered waveguide display.

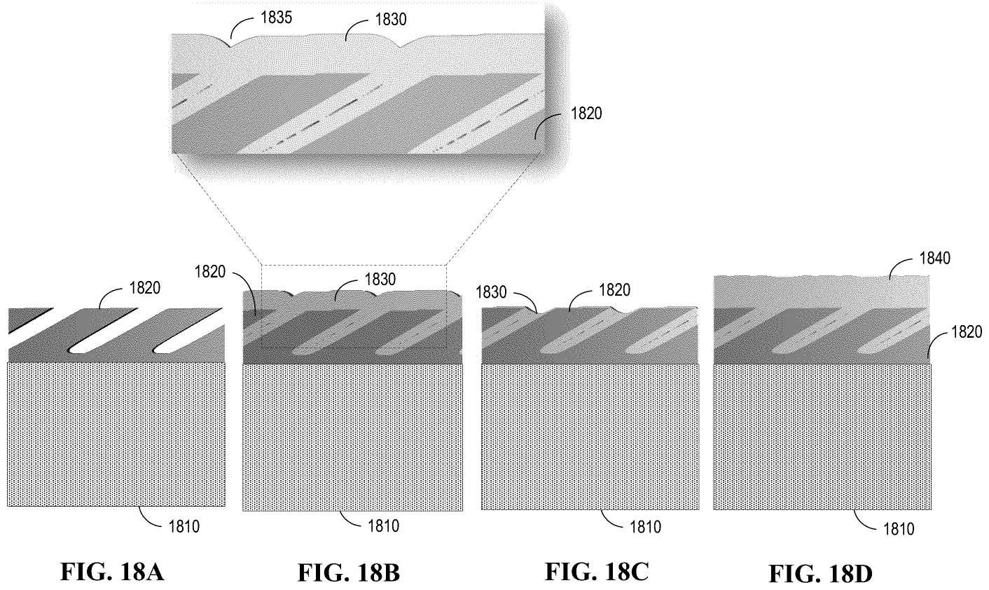

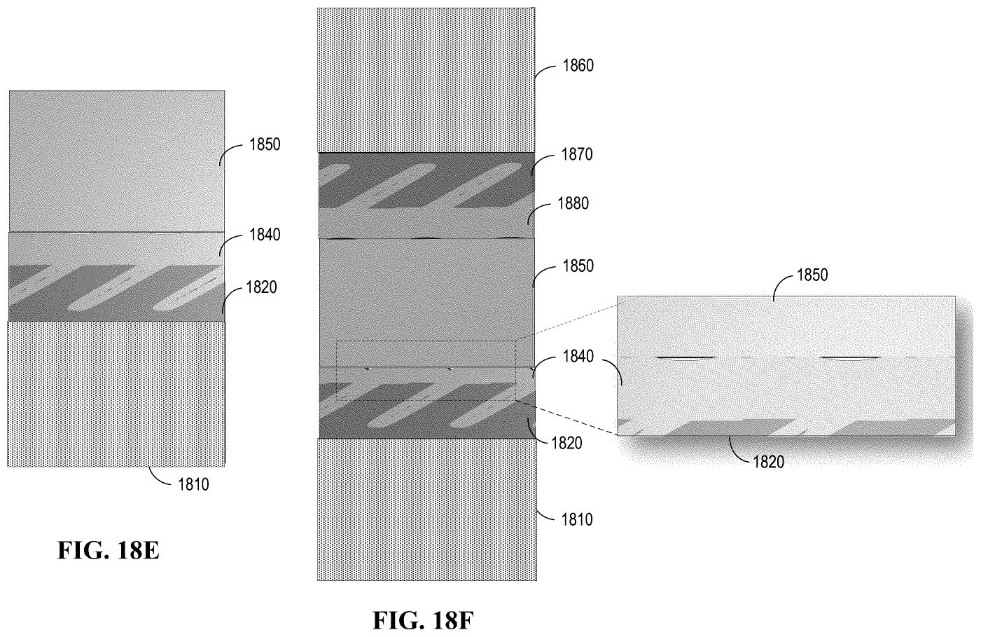

FIGS. 18A-18F illustrate an example of a process of fabricating a waveguide display including a layered waveguide according to certain embodiments. The process shown in FIGS. 18A-18F may be an example of the process of FIG. 17. FIG. 18A shows a surface-relief grating 1820 imprinted in an imprint material layer deposited on a first substrate 1810. In one example, first substrate 1810 may include a glass substrate having a refractive index about 1.7, and the imprint material may have a refractive index about 1.5. Surface-relief grating 1820 may be slanted and may have a variable depth, a variable grating period, a variable duty cycle, and/or a variable slant angle. In addition, the imprint material between first substrate 1810 and the bottom of the grating grooves may be thin (e.g., close to zero). For example, the bottom of a deepest grating groove may be at the top surface of first substrate 1810.

FIG. 18B illustrates an example of a layer of a high-index backfill material 1830 deposited on SRG 1820 to fill the grating grooves of SRG 1820. As described above, in one example, a plurality of ALD cycles may be performed to fill the grating grooves of SRG 1820. One example of high-index backfill material 1830 is TiOₓ, which may have a refractive index about 2.3. As illustrated by the inset of FIG. 18B, the top surface of the layer of high-index backfill material 1830 may not be flat and may include dips 1835, which may not be suitable for bonding with another substrate or layer. For example, air pockets may form at dips 1835 when the layer of high-index backfill material 1830 is bonded to another substrate (e.g., a high-index substrate). The air pockets may result in high optical loss and image quality reduction due to, for example, light reflection and/or diffusion at the air pockets.

FIG. 18C illustrates an optional process of etching or otherwise thinning the layer of high-index backfill material 1830 to at least partially remove the deposited high-index backfill material 1830 on top of the grating ridges, and/or planarize the top surface of the layer of high-index backfill material 1830. The layer of high-index backfill material 1830 may be thinned using, for example, etching (e.g., wet or dry etching, vertical or slanted etching, etc.), CMP, grayscale lithography, or other processes that may planarize and/or thin the layer of high-index backfill material 1830. In some embodiments, the etching or other thinning processes may reduce the ripples or dips at the top surface of the layer of high-index backfill material 1830. In some embodiments, a standard clean 1 (SC1) process may be performed to clean the surface of the remaining high-index backfill material 1830. In the example shown in FIG. 18C, high-index backfill material 1830 on top of the grating ridges of SRG 1820 may be removed and the grating grooves of SRG 1820 may remain filled with high-index backfill material 1830.

FIG. 18D shows an example of an index-matching material layer 1840 deposited on SRG 1820 and high-index backfill material 1830 in the grating grooves of SRG 1820. Index-matching material layer 1840 may have a refractive index close to (e.g., within about +0.05 from) the refractive index of the high-index substrate of the layered waveguide. In one example, index-matching material layer 1840 may include TiOₓ and may have a refractive index about 2.3. In some embodiments, the thickness of index-matching material layer 1840 may be between about 20 nm and about 20 μm.

FIG. 18E shows a high-index substrate 1850 bonded to index-matching material layer 1840 using, for example, fusion bonding. In one example, high-index substrate 1850 may include LN, and may have a refractive index about 2.3. The bonding may be performed at a temperature no more than about 400°, such as near room temperatures. As described above, in some embodiments, a layer of the index-matching material (e.g., TiOₓ) may be deposited on high-index substrate 1850 (e.g., by PCD) before the bonding, such that the bonding may be between the index-matching material on high-index substrate 1850 and the same index-matching material in index-matching material layer 1840 and thus may be directly bonded using fusion bonding at near room temperatures.

FIG. 18F shows that another SRG 1870 may be imprinted in an imprint material layer (e.g., with an RI about 1.5) deposited on a second substrate 1860 (e.g., a glass substrate with an RI about 1.7), and may be filled with a high-index backfill material (e.g., TiOₓ) and deposited with an index-matching material layer 1880 (e.g., including TiOₓ) as described above with respect to FIGS. 18A-18D. Second substrate 1860 with SRG 1870 and index-matching material layer 1880 may then be bonded to a second side of high-index substrate 1850 (e.g., an index-matching material layer deposited on the second side of high-index substrate 1850). As such, a layered waveguide including three substrates and buried SRGs may be formed. Similar processes may be performed to add more substrate layers and more imprinted SRGs to the layered waveguide structure.

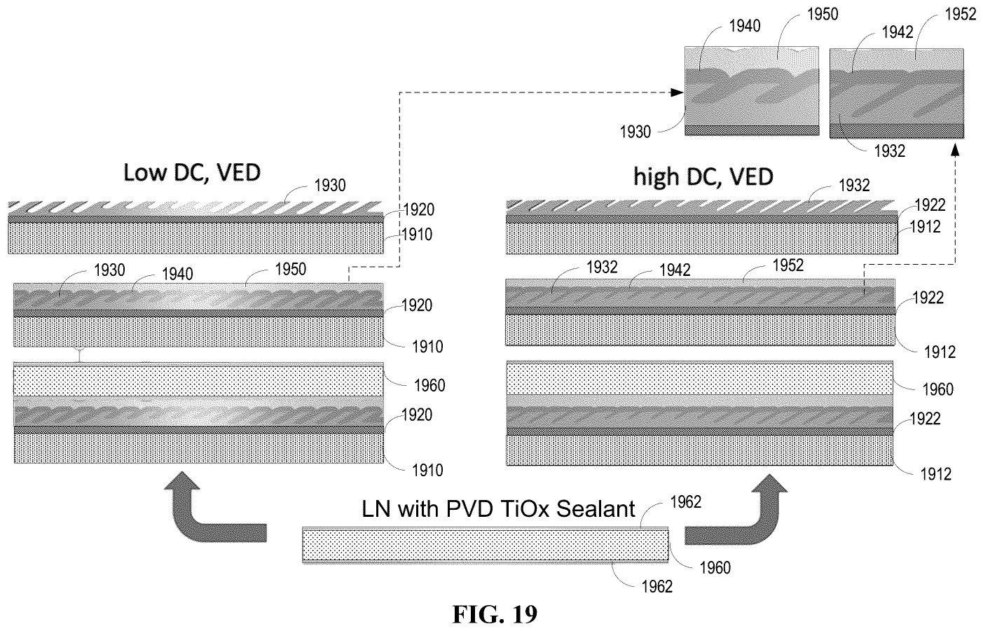

FIG. 19 illustrates an example of a process of fabricating waveguide displays including a layered waveguide according to certain embodiments. In the illustrated example, a first SRG 1930 with a variable grating depth and low duty cycles may be imprinted in an imprint material layer 1920 deposited on a glass substrate 1910 (e.g., with an RI about 1.5-1.7), where the refractive index of the imprint material (e.g., an organic material) may be, for example, about 1.5, and the slanted angle of the grating ridges may be, for example, about 60°. The first SRG 1930 may be backfilled with a high-index backfill material 1940 (e.g., TiOₓ with an RI about 2.3) using, for example, a plurality of cycles of ALD, and an index-matching material layer 1950 (e.g., including TiOₓ with an RI about 2.3) may be deposited on the first SRG 1930 using, for example, PVD processes. A high-index substrate 1960 (e.g., a lithium niobate substrate with an RI about 2.3) may be cleaned and coated with a index-matching material 1962 on the top and/or bottom surfaces of substrate 1960 using, for example, PVD processes. The index-matching material layer 1950 of the first SRG 1930 may then be bonded to the index-matching material 1962 on the top and/or bottom surfaces of substrate 1960 using, for example, low-temperature fusion bonding.

Similarly, a second SRG 1932 with a variable grating depth and large duty cycles may be imprinted in imprint material layer 1922 deposited on another glass substrate 1912 (e.g., with an RI about 1.5-1.7), where the refractive index of the imprint material (e.g., an organic material) may be, for example, about 1.5, and the slanted angle of the grating ridges may be, for example, about 60°. The second SRG 1932 may be backfilled with a high-index backfill material 1942 (e.g., TiOₓ with an RI about 2.3) using, for example, a plurality of cycles of ALD, and an index-matching material layer 1952 (e.g., including TiOₓ with an RI about 2.3) may be deposited on the second SRG 1932 using, for example, PVD processes. The index-matching material layer 1952 of the second SRG 1932 may then be bonded to the index-matching material 1962 on the top and/or bottom surfaces of substrate 1960 using, for example, low-temperature fusion bonding.

It is noted that the specific materials, grating parameters, and processing technology described above with respect to FIG. 19 are for illustrative purposes only. In other embodiments, different materials, grating parameters, and processing technology may be used. In one example, gratings may be fabricated on a surface of a low-index substrate (e.g., a glass substrate), and a high-index substrate may then be bonded to the grating/glass substrate.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

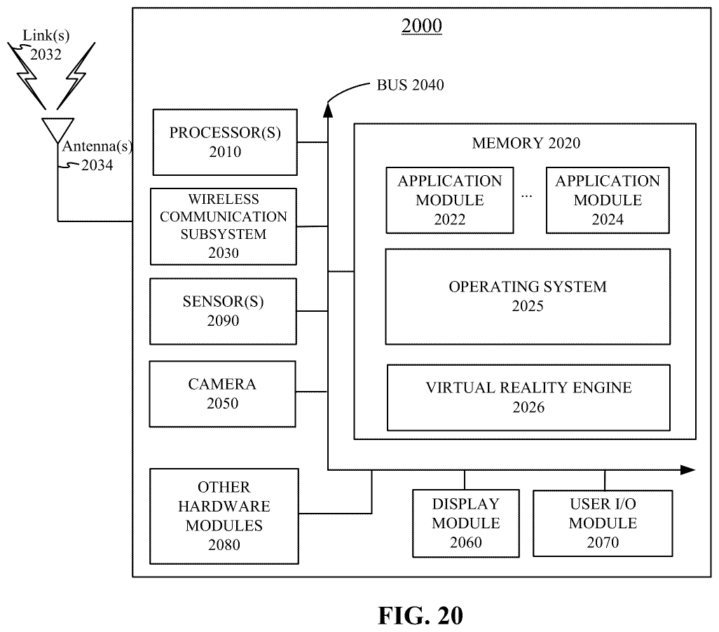

FIG. 20 is a simplified block diagram of an example electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or dynamic random access memory (DRAM) and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program modules, and other data for electronic system 2000. In some embodiments, memory 2020 may be distributed into different hardware modules. A set of instructions and/or code might be stored on memory 2020. The instructions might take the form of executable code that may be executable by electronic system 2000, and/or might take the form of source and/or installable code, which, upon compilation and/or installation on electronic system 2000 (e.g., using any of a variety of generally available compilers, installation programs, compression/decompression utilities, etc.), may take the form of executable code.

In some embodiments, memory 2020 may store a plurality of application modules 2022 through 2024, which may include any number of applications. Examples of applications may include gaming applications, conferencing applications, video playback applications, or other suitable applications. The applications may include a depth sensing function or eye tracking function. Application modules 2022-2024 may include particular instructions to be executed by processor(s) 2010. In some embodiments, certain applications or parts of application modules 2022-2024 may be executable by other hardware modules 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by application modules 2022-2024 and/or manage other hardware modules 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2000 may include a display module 2060. Display module 2060 may be a near-eye display, and may graphically present information, such as images, videos, and various instructions, from electronic system 2000 to a user. Such information may be derived from one or more application modules 2022-2024, virtual reality engine 2026, one or more other hardware modules 2080, a combination thereof, or any other suitable means for resolving graphical content for the user (e.g., by operating system 2025). Display module 2060 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 2000 may include a user input/output module 2070. User input/output module 2070 may allow a user to send action requests to electronic system 2000. An action request may be a request to perform a particular action. For example, an action request may be to start or end an application or to perform a particular action within the application. User input/output module 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments, user input/output module 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3-D images.

In some embodiments, electronic system 2000 may include a plurality of other hardware modules 2080. Each of other hardware modules 2080 may be a physical module within electronic system 2000. While each of other hardware modules 2080 may be permanently configured as a structure, some of other hardware modules 2080 may be temporarily configured to perform specific functions or temporarily activated. Examples of other hardware modules 2080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or some combination thereof of the HMD device from the various sensors. In some embodiments, the information received by virtual reality engine 2026 may be used for producing a signal (e.g., display instructions) to display module 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output module 2070 and provide feedback to the user. The provided feedback may be visual, audible, or haptic feedback. In some implementations, processor(s) 2010 may include one or more GPUs that may execute virtual reality engine 2026.

In various implementations, the above-described hardware and modules may be implemented on a single device or on multiple devices that can communicate with one another using wired or wireless connections. For example, in some implementations, some components or modules, such as GPUs, virtual reality engine 2026, and applications (e.g., tracking application), may be implemented on a console separate from the head-mounted display device. In some implementations, one console may be connected to or support more than one HMD.

In alternative configurations, different and/or additional components may be included in electronic system 2000. Similarly, functionality of one or more of the components can be distributed among the components in a manner different from the manner described above. For example, in some embodiments, electronic system 2000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or” as used herein may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Also, in this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A waveguide display comprising:
a first substrate characterized by a first refractive index;
a first surface-relief grating formed on a second substrate, wherein the first surface-relief grating and the second substrate are characterized by a second refractive index and a third refractive index, respectively; and
a first index-matching material layer between the first substrate and the first surface-relief grating, the first index-matching material layer filling grating grooves of the first surface-relief grating and characterized by a fourth refractive index,
wherein:
the fourth refractive index matches the first refractive index,
the third refractive index is lower than the first refractive index, and
the second refractive index is lower than the first refractive index.

2. The waveguide display of claim 1, wherein the first refractive index is greater than 2.0.

3. The waveguide display of claim 1, wherein the first surface-relief grating is formed on the second substrate using nanoimprint lithography.

4. The waveguide display of claim 1, wherein the first surface-relief grating is characterized by:
a variable grating period,
a variable grating depth,
a variable duty cycle,
a variable grating ridge slant angle, or
a combination thereof.

5. The waveguide display of claim 1, wherein the second refractive index is between 1.4 and 1.9.

6. The waveguide display of claim 1, wherein the third refractive index is between 1.5 and 2.0.

7. The waveguide display of claim 1, wherein the first surface-relief grating is characterized by a grating ridge slant angle between 0° and 70°.

8. The waveguide display of claim 1, wherein the first surface-relief grating is characterized by a grating depth between 0 and 1 μm.

9. The waveguide display of claim 1, wherein the first surface-relief grating is characterized by a duty cycle between 0.1 and 0.9.

10. The waveguide display of claim 1, wherein the first surface-relief grating is characterized by a grating period between 150 nm and 700 nm.

11. The waveguide display of claim 1, further comprising:
a second surface-relief grating formed on a third substrate, wherein the second surface-relief grating and the third substrate are characterized by a fifth refractive index and a sixth refractive index, respectively, and wherein the fifth refractive index and the sixth refractive index are lower than the first refractive index; and
a second index-matching material layer between the first substrate and the second surface-relief grating, the second index-matching material layer filling grating grooves of the second surface-relief grating and characterized by the fourth refractive index.

12. The waveguide display of claim 1, wherein:
the first substrate includes SiC or LiNbO₃; and
the first index-matching material layer includes TiOₓ.

13. A method comprising:
imprinting a first surface-relief grating on a first substrate, wherein the first substrate and the first surface-relief grating are characterized by a first refractive index and a second refractive index, respectively;
filling grating grooves of the first surface-relief grating with a backfill material, the backfill material characterized by a third refractive index greater than the first refractive index and the second refractive index;
depositing a first layer of an index-matching material on the first surface-relief grating, the index-matching material characterized by a fourth refractive index greater than the first refractive index and the second refractive index; and
bonding the first layer of the index-matching material on the first surface-relief grating to a first side of a second substrate, the second substrate characterized by a fifth refractive index matching the fourth refractive index.

14. The method of claim 13, wherein the backfill material is the same as the index-matching material.

15. The method of claim 13, wherein filling the grating grooves of the first surface-relief grating with the backfill material includes depositing a plurality of thin layers of the backfill material in a plurality of cycles of atomic layer deposition.

16. The method of claim 13, further comprising etching the backfill material before depositing the first layer of the index-matching material on the first surface-relief grating.

17. The method of claim 13, further comprising:
depositing a second layer of the index-matching material on the first side of the second substrate,
wherein bonding the first layer of the index-matching material on the first surface-relief grating to the first side of the second substrate comprises bonding the first layer of the index-matching material on the first surface-relief grating to the second layer of the index-matching material on the first side of the second substrate.

18. The method of claim 13, further comprising:
imprinting a second surface-relief grating on a third substrate, wherein the third substrate and the second surface-relief grating are characterized by a sixth refractive index and a seventh refractive index, respectively, and wherein the sixth refractive index and the seventh refractive index are lower than the fourth refractive index of the index-matching material;
filling grating grooves of the second surface-relief grating with the backfill material;
depositing a second layer of the index-matching material on the second surface-relief grating; and
bonding the second layer of the index-matching material on the second surface-relief grating to a second side of the second substrate.

19. The method of claim 13, wherein depositing the first layer of the index-matching material on the first surface-relief grating comprises depositing the first layer of the index-matching material on the first surface-relief grating using physical vapor deposition.

20. The method of claim 13, wherein bonding the first layer of the index-matching material on the first surface-relief grating to the first side of the second substrate comprises bonding the first layer of the index-matching material on the first surface-relief grating to the first side of the second substrate by fusion bonding at a temperature below 400° C.
